(19) United States
(12) Patent Application Publication
(10) Pub. No.: US 2019/0118258 A1
(43) Pub. Date: Apr. 25, 2019

(54) NOZZLE SERVICING TECHNIQUES FOR ADDITIVE FABRICATION SYSTEMS

(71) Applicant: Desktop Metal, Inc., Burlington, MA (US)

(72) Inventors: Emanuel Michael Sachs, Newton, MA (US); Uwe Bauer, Cambridge, MA (US); Nicholas Graham Bandiera, Burlington, MA (US); Mark Gardner Gibson, Carlisle, MA (US)

(21) Appl. No.: 16/125,181

(22) Filed: Sep. 7, 2018

Related U.S. Application Data
(60) Provisional application No. 62/575,133, filed on Oct. 20, 2017.

(51) Int. Cl. B22F 3/00; B33Y 40/00; B33Y 30/00; B33Y 50/02

(52) U.S. Cl. CPC B22F 3/008; B33Y 40/00; B33Y 10/00; B33Y 50/02; B33Y 30/00

(57) ABSTRACT

3D printing using metal containing multi phase materials is prone to nozzle clogging and flow artifacts. These can be mitigated by monitoring process conditions and taking action at times based on other conditions. Forces, physical regularity, and temperatures can be monitored and service can be taken based on these, immediately, or at dynamic future points, short or longer term, such as completion of a segment or layer, or before critical geometry. Process conditions can be logged and service time can be based on functions of individual and combinations of logged data. Operating windows can be adjusted based on same. Service includes dwell time at high and low temperatures, treatment material provided into the nozzle to change the liquid composition therein. Plungers and fluid jets can expel material from nozzle inlet or outlet. Dwelling at various temperatures can liquefy clogs or cause rupture by disparate volume changes of cooling materials.

### CROSS-REFERENCE TO RELATED APPLICATIONS

This application claims priority to U.S. Provisional App. No. 62/575,133, filed on Oct. 20, 2017, entitled Semi-Solid Metal Additive Manufacturing, the full disclosure of which is hereby incorporated by reference in its entirety.

This application is also related to the following U.S. patent applications: U.S. Prov. App. No. 62/268,458, filed on Dec. 16, 2015; U.S. application Ser. No. 15/382,535, filed on Dec. 16, 2016; International App. No. PCT/US17/20817 filed on Mar. 3, 2017; U.S. application Ser. No. 15/450,562, filed on Mar. 6, 2017; U.S. Prov. App. No. 62/303,310, filed on Mar. 3, 2016; U.S. application Ser. No. 15/059,256, filed on Mar. 2, 2016; U.S. application Ser. No. 16/035,296, filed on Jul. 13, 2018; and U.S. application Ser. No. 16/038,057, filed on Jul. 17, 2018. Each the foregoing applications is hereby incorporated herein by reference in its entirety.

### TECHNICAL FIELD

The present disclosure generally relates to additive manufacturing, and more specifically to a fused filament fabrication using a nozzle and metal containing multi-phase build material, and more specifically to the three-dimensional printing of metal objects, and apparatus and methods for servicing nozzles and other apparatus components used in such printing, including but not limited to clearing mitigating and clearing clogs and other flow artifacts.

### BACKGROUND

Fused filament fabrication (FFF) provides a technique for fabricating three-dimensional objects from a thermoplastic or similar materials. Machines using this technique can fabricate three-dimensional objects additively by depositing segments of material in layers to additively build up a physical object from a computer model. Such segments are also referred to herein and within the industry as roads, beads, and lines. While these polymer-based techniques have been changed and improved over the years, the physical principles applicable to polymer-based systems may not be applicable to metal-based systems, which tend to pose different challenges. There remains a need for three-dimensional printing techniques suitable for metal additive manufacturing.

### SUMMARY

Flow artifacts within an extruder of an extrusion-based additive manufacturing system can lead to accumulations of solidified material that clog a nozzle of the extruder or otherwise interfere with movement of material through the extruder, particularly where the extrudate includes metal containing multi-phase metal materials or the like. By employing various techniques, these artifacts can be prevented, mitigated, anticipated, or otherwise remediated, and resulting flow interruptions can be avoided or minimized. Some suitable servicing techniques include, but are not limited to, sensing incipient or occurring flow artifacts and taking remedial service. Sensing can be by various methods, including sensing forces upon the build material as it is introduced to or within or leaving a nozzle, optical inspection of build material at all stages, sensing temperature of the build material within the nozzle, and current in a build material drive system. In addition to or instead of sensing flow artifacts, anticipatory action can be taken based on the occurrence process conditions based on combinations of sensed criteria, functions of these, or functions of combinations of criteria.

Forces, physical regularity, and temperatures can be monitored, and service can be taken based on these, immediately, or at dynamic future points, short or longer term, such as completion of a segment or layer or before critical geometry. Process conditions can be logged and service time can be based on functions of individual and combinations of logged data. Operating windows can be adjusted based on the same. Service procedures include dwell time at high and low temperatures, treatment material provided into the nozzle to change the liquid composition therein. Plungers and fluid jets can expel material from nozzle inlet or outlet. Dwelling at various temperatures can liquefy clogs or cause rupture by disparate volume changes of cooling material.

More specifically, an embodiment for a method hereof is a method for servicing a nozzle of a three-dimensional printer, used for fabricating an object based on a computerized model of the object, by extruding metal containing multi-phase (MCMP) build material from the nozzle, the printer also comprising a build region, the nozzle having an inlet and an outlet, the steps of fabrication including feeding the MCMP build material into the nozzle inlet, and extruding MCMP build material from the nozzle outlet while establishing relative motion of the nozzle outlet relative to the build region along a build path to fabricate the object within the build region. The method for servicing comprises: a. establishing at least one operating window size, at the conclusion of which nozzle service is scheduled; b. establishing at least one process condition: c. during the operating window, simultaneously with the steps of feeding, extruding and establishing relative motion of the nozzle outlet, monitoring at least one process condition. If the at least one processing condition has not arisen, continuing with the steps c. of feeding, extruding and establishing relative motion of the nozzle outlet and simultaneously monitoring whether the at least one processing condition has arisen; and if the at least one processing condition has arisen, conducting the following: changing the size of the operating window; continuing the steps of feeding, extruding and establishing relative motion of the nozzle outlet until conclusion of the operating window with changed size, and then conducting nozzle service; and conducting the step c. above, during the operating window with changed size, the steps of feeding, extruding and establishing relative motion of the nozzle and simultaneously monitoring whether the at least one processing condition has arisen. The operating window size can be reduced or enlarged, either once, or multiple times before service is conducted. Service generally continues until an operating window, either as originally or changed sized, concludes. The size of the operating window can be measured by at least one of the group consisting of: elapsed extruding time; elapsed absolute time, extruded distance, extruded mass, extruded volume, number of extruded segments, number of extruded layers; and amount of extruding, as measured by any one of the foregoing, before next critical geometry. The printer further typically has a build material feeder system, and the at least one process condition can be selected from the group consisting of: extrusion force, optically observed condition of build material as extruded, elapsed extrusion time, distance of material deposited, mass of material deposited, volume of material deposited, number of segments deposited, number of layers deposited, average of any of the foregoing, moving average of any of the foregoing, and exponentially weighted moving average of any of the foregoing. The material feeder system can comprise an electric motor, and the at least one process condition can comprise current drawn by the motor. The build material can be extruded in a set of individual segments, and the step of changing the size of the operating window can comprise changing it to a size so that it terminates after completion of an individual segment and before beginning an individual segment. Further, typically the segments are extruded in layers, and the step of changing the size of the operating window can comprise changing it to a size so that it terminates after completion of an individual layer and before beginning an individual layer. The processing condition can comprise a preset or dynamic value.

Another embodiment for a method hereof is a method for servicing a nozzle of a three-dimensional printer, used for fabricating an object based on a computerized model of the object, by extruding metal containing multi-phase (MCMP) build material from the nozzle, the printer also comprising a build region, the nozzle having an inlet and an outlet, the steps of fabrication including feeding the MCMP build material into the nozzle inlet, and extruding MCMP build material from the nozzle outlet while establishing relative motion of the nozzle outlet in a set of individual segments relative to the build region along a build path to fabricate the object within the build region. The method for servicing comprises: establishing at least one operating window size, at the conclusion of which nozzle service is scheduled; establishing at least one process condition; an during the operating window, simultaneously with the steps of feeding, extruding and establishing relative motion of the nozzle outlet, monitoring at least one process condition. If the at least one processing condition has not arisen, continuing with the steps of feeding, extruding and establishing relative motion of the nozzle outlet and simultaneously monitoring whether the at least one processing condition has arisen until conclusion of the operating window. If the at least one processing condition has arisen, continuing the steps of feeding, extruding and establishing relative motion of the nozzle outlet until after a segment has been extruded, and then, before extruding an additional segment, conducting nozzle service. Service can be conducted before extruding the next upcoming segment, or a future upcoming segment, after a plurality of segments have been extruded. The same processes conditions as mentioned above can be used, either short term, individual values measured, or longer term functions or extrapolations of such process conditions, either individually or in combination.

Yet another embodiment of a method hereof is method for servicing a nozzle of a three-dimensional printer, used for fabricating an object based on a computerized model of the object, by extruding metal containing multi-phase (MCMP) build material from the nozzle, the printer also comprising a build region, the nozzle having an inlet and an outlet, the steps of fabrication including feeding the MCMP build material into the nozzle inlet, and extruding MCMP build material from the nozzle outlet in a set of individual segments, each segment having a size, while establishing relative motion of the nozzle outlet relative to the build region along a build path to fabricate the object within the build region. The method for servicing comprises: establishing at least one operating window size at the conclusion of which a nozzle service is scheduled; establishing at least process condition; and during the operating window, simultaneously with the steps of feeding, extruding and moving the nozzle, monitoring at least one process condition, and determining whether the at least one process condition will arise before completion of an upcoming segment. If not, continuing with the steps of feeding, extruding and establishing relative motion of the nozzle outlet and determining whether the at least one process condition will arise before completion of an upcoming segment. If the at least one processing condition will arise before completion of an upcoming segment: the method comprises taking a step chosen from the three options. One is continuing feeding the MCMP build material into the nozzle inlet and extruding MCMP build material from the nozzle outlet while establishing relative motion of the nozzle outlet along a build path to fabricate the object, until the end of the upcoming segment has been extruded, and then conducting nozzle service. A second option is ceasing feeding the MCMP build material into the nozzle inlet and ceasing extruding MCMP build material from the nozzle outlet and conducting nozzle service before fabricating the upcoming segment. A third option is splitting the upcoming segment into a plurality of shorter segments, and continuing feeding the MCMP build material into the nozzle inlet and extruding MCMP build material from the nozzle outlet while establishing relative motion of the nozzle outlet along a build path to fabricate the object, until the end of the at least one of the plurality of shorter segments has been extruded, and then conducting nozzle service. The choice can be made with respect to the next upcoming segment, or a future upcoming segment, based on the build path and computer model.

Still another method embodiment hereof is a method for servicing a nozzle of a three-dimensional printer, used for fabricating an object based on a computerized model of the object, by extruding metal containing multi-phase (MCMP) build material from the nozzle, the printer also comprising a build region, the nozzle having an inlet and an outlet, the steps of fabrication including feeding the MCMP build material into the nozzle inlet, establishing the nozzle at an operating temperature, and extruding MCMP build material from the nozzle outlet while establishing relative motion of the nozzle outlet relative to the build region along a build path to fabricate the object within the build region. The method for servicing comprises: ceasing feeding the MCMP build material into the nozzle and ceasing extruding MCMP build material from the nozzle; moving the nozzle away from the build path to a service area; conducting nozzle service by ejecting a quantity of build material from the nozzle; returning the nozzle to the build path; and restarting and continuing with the steps of feeding, extruding and establishing relative motion of the nozzle outlet. Before ejecting a quantity of build material, the temperature of the nozzle can be increased. Ejecting build material can comprise driving build material into the nozzle inlet, which can be conducted at constant or varying drive speeds, and also in both forward and reverse directions. Ejecting a build material from the nozzle can comprise inserting a plunger into the nozzle, either into the inlet or the outlet. One ore more plungers (in series) can be inserted. The plunger can soften and deform when pressed against the nozzle outlet, thereby capturing material built up within the nozzle. The capture can be mechanical, chemical, adhesive, or other means. A pressure differential can be provided to eject material either out of the nozzle inlet or outlet, the pressure differential being directed in either direction. The pressure differential can be established by forcing a fluid of gas or liquid through the nozzle.

Another method embodiment is a method for servicing a nozzle of a three-dimensional printer, used for fabricating an object based on a computerized model of the object, by extruding metal containing multi-phase (MCMP) build material from the nozzle, the printer also comprising a build region, the nozzle having an inlet and an outlet, the steps of fabrication including feeding the MCMP build material into the nozzle inlet, establishing the nozzle at an operating temperature, and extruding MCMP build material from the nozzle outlet while establishing relative motion of the nozzle outlet relative to the build region along a build path to fabricate the object within the build region. The method for servicing comprises: ceasing feeding the MCMP build material into the nozzle and ceasing extruding MCMP build material from the nozzle; and maintaining the nozzle at a temperature for a dwell time. The maintained temperature can be the operating temperature, or an elevated or a reduced temperature. The elevated temperature can be above the liquidus of the build material, and the reduced temperature can be below the solidus of the build material. A treatment material can be provided into the nozzle, either in solid or liquid form, preferably sold. The treatment material can have a composition that is chosen such that it increases the liquid fraction of the material in the nozzle to a level close to or above the one expected for the build material composition. The treatment material can be provided to the nozzle inlet or outlet. After it is provided, build material can be driven into the nozzle, thereby expelling material residing in the nozzle.

One more method embodiment is a method for servicing a nozzle of a three-dimensional printer, used for fabricating an object based on a computerized model of the object, by extruding metal containing multi-phase (MCMP) build material from the nozzle, the printer also comprising a build region, the nozzle having an inlet and an outlet, the steps of fabrication including feeding the MCMP build material into the nozzle inlet, and extruding MCMP build material from the nozzle outlet while establishing relative motion of the nozzle outlet relative to the build region along a build path to fabricate the object within the build region. The method for servicing comprises: establishing at least one operating window size, at the conclusion of which nozzle service is scheduled; establishing at least one nozzle health replacement condition; and during the operating window, simultaneously with the steps of feeding, extruding and establishing relative motion of the nozzle outlet, monitoring at least one nozzle health replacement condition. If the at least one nozzle health replacement condition has not arisen, continuing with the steps of feeding, extruding and establishing relative motion of the nozzle outlet and simultaneously monitoring whether the at least one processing condition has arisen If the at least one nozzle health replacement condition has arisen, replacing the nozzle.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 shows schematically, in block diagram form, an additive manufacturing system.

FIG. 2 shows schematically, in flow chart form, a method for operating and monitoring a printer in a three-dimensional fabrication of an object.

FIG. 3 shows, schematically, an extruder for fused filament fabrication additive manufacturing, including various sensors.

FIG. 4 shows a phase diagram for a generic eutectic system, for which, within a temperature range, there are compositions that exist in a multi-phase condition of at least one solid phase and one liquid phase.

FIG. 5 shows schematically, in flow chart form, a method of reacting to sensed flow impediments in a nozzle, taking remedial action, and resuming deposition largely uninterrupted.

FIG. 6 shows schematically, in flow chart form, a method of operating a printer with a predefined nozzle service schedule without taking into account upcoming path segments.

FIG. 7 shows schematically, in flow chart form, a method of operating a printer with a predefined nozzle service schedule and taking account of upcoming path segments.

FIG. 8 shows a schematic plan view of a printer and object during printing, including various path segments and traverses to a nozzle service region.

FIG. 9 shows schematically, in flow chart form, a method for a nozzle service routine incorporating a self-test extrusion.

FIG. 10 shows a schematic plan view of two deposited segments of build material, one with defects and one without defects.

FIG. 11 shows schematically, in flow chart form, a method of operating a printer with a nozzle processing window adaptably sized based upon long term process conditions or behaviors.

FIG. 12 shows schematically, in flow chart form, a method of operating a printer with a processing window dynamically sized and/or timed based upon short term process conditions.

FIG. 13 shows schematically, in flow chart form, a method of adapting a nozzle service schedule based upon importance of upcoming geometry.

FIG. 14 shows schematically, in flow chart form, a method for nozzle service involving a dwell time at a temperature.

FIG. 15 shows schematically, in flow chart form, a method for nozzle service involving moving the nozzle away from the object build region and feeding build material.

FIG. 16 shows schematically, in flow chart form, a method for nozzle service involving heating and cooling the nozzle

FIG. 17 shows schematically, in flow chart form, a method for nozzle service involving retracting the build material and heating the nozzle.

FIG. 18 shows schematically, in flow chart form, a method for nozzle service involving heating the nozzle and feeding the build material.

FIG. 19 shows a representative phase diagram showing a material that may be used in a service routine that involves providing a volume of treatment material to the nozzle.

FIG. 20 shows schematically a nozzle service routine involving a forced gas flow in which material is ejected out of a nozzle outlet.

FIG. 21 shows schematically a nozzle service routine involving a forced gas flow in which material is ejected out of a nozzle inlet.

FIG. 22 shows schematically, in flow chart form, a method for nozzle service involving cooling and reheating the nozzle.

FIG. 23 shows a representative phase diagram showing a material composition the printing of which is conducive to a nozzle service routine involving cooling and reheating the nozzle.

FIG. 24 shows schematically a nozzle service routine using a plunger to expel material out of the nozzle outlet.

FIG. 25 shows schematically a method for nozzle service using a tool to capture material and withdraw it out from the nozzle inlet, and then to separate the end of the tool and provide additional length of the tool in a continuous fashion.

FIG. 26 shows schematically a portion of a tool such as is shown in FIG. 25, including retained material to be removed.

FIG. 27 shows schematically, in flow chart form, a method for nozzle service involving adding a metallurgical treatment to the nozzle.

### DETAILED DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

Before a discussion of specific teachings, a discussion of general FFF3D printing equipment suitable for use with the present teachings will be described. Mention will also be made of the materials for which benefits have been found using the techniques disclosed herein.

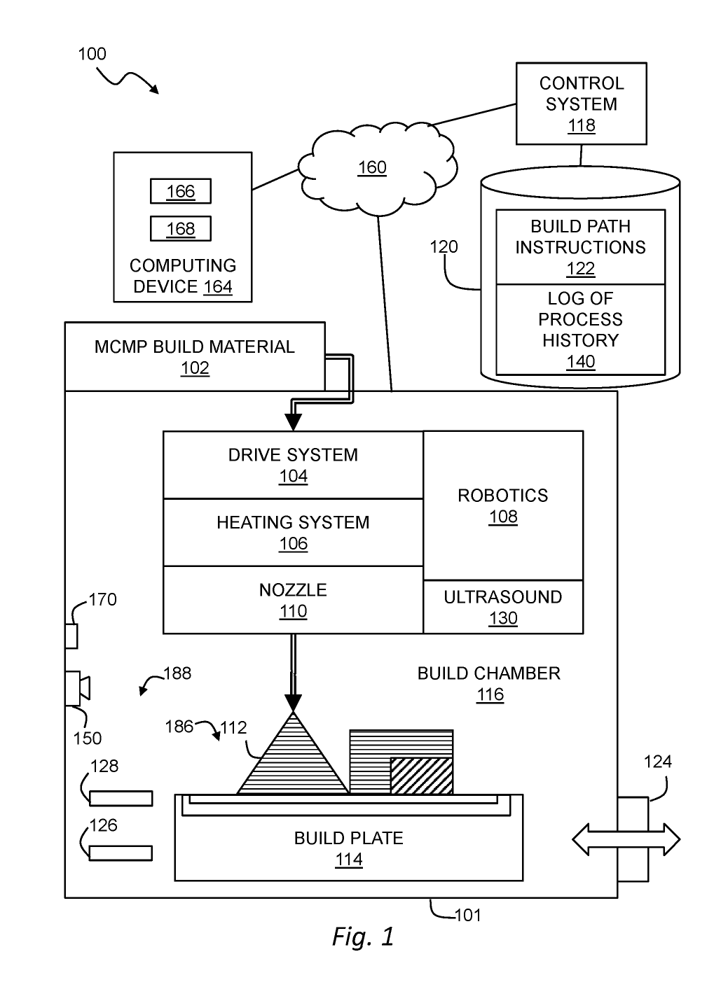

FIG. 1 is a schematic block diagram of an additive manufacturing system 100. In general, the additive manufacturing system may include a three-dimensional printer 101 (or simply printer 101) that deposits a metal, metal alloy, metal composite or the like, using fused filament fabrication or any similar process. In general, the printer 101 may include a multi-phase metallic build material 102 that is propelled by a drive system 104 and heated to an extrudable state by a heating system 106, and then extruded through one or more nozzles 110. By concurrently controlling robotics 108 to position the nozzle(s) along an extrusion path relative to a build plate 114, an object 112 may be fabricated on the build plate 114 which may be situated within a build chamber 116. In general, a control system 118 may manage operation of the printer 101 to fabricate the object 112 according to build path instructions 122 based on a three-dimensional model using a fused filament fabrication process or the like. The types of materials suitable as a build material are discussed below.

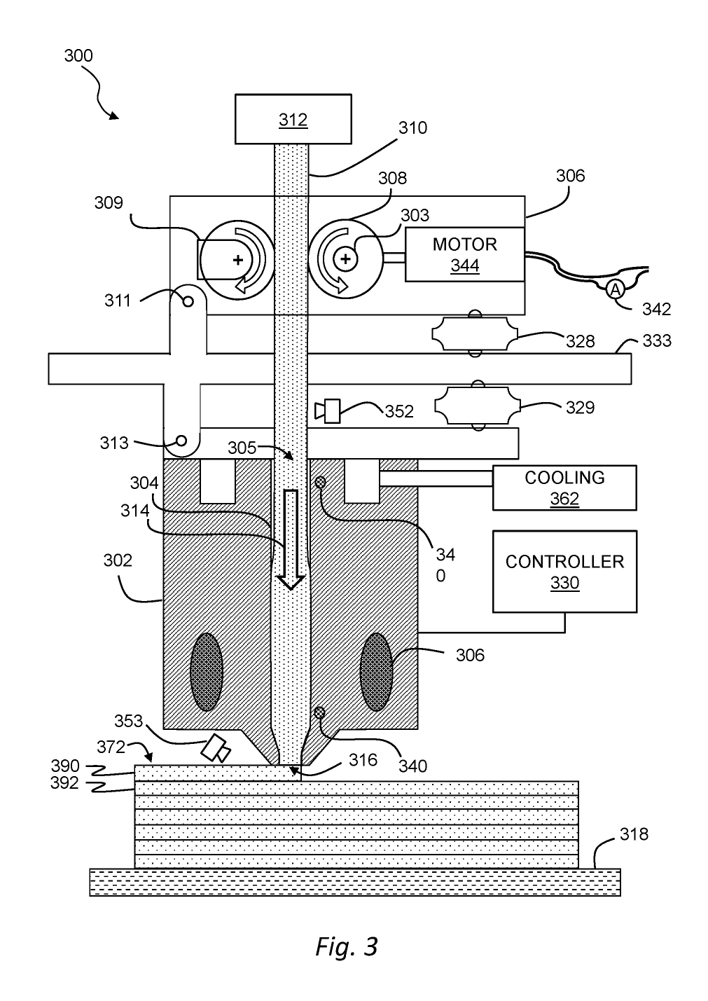

FIG. 3 shows an extruder 300 for a three-dimensional printer. In general, the extruder 300 may include a nozzle 302, a nozzle bore 304, a heating system 306, and a build material drive system 308 such as any of the systems described herein, or any other devices or combination of devices suitable for a printer that fabricates an object from a computerized model using a fused filament fabrication process and a metallic build material as contemplated herein. In general, the extruder 300 may receive a build material 310 from a source 312, such as any of the build materials and sources described herein, and advance the build material 310 along a feed path (indicated generally by an arrow 314) toward an opening 316 of the nozzle 302 for deposition on a build plate 318 or other suitable surface. The term build material is used herein interchangeably to refer to metallic build material, species and combinations of metallic build materials, or any other build materials, all as discussed below. As such, references to build material 310 should be understood to include metallic build materials, or multi-phase metallic build materials or any of the other build material or combination of build materials described herein, under specific conditions, unless a more specific meaning is provided or otherwise clear from the context.

Many metallic build materials may be used with the techniques described herein. In general, any build material with metallic content that provides a useful working temperature range with rheological behavior suitable for heated extrusion may be used as a metallic build material as contemplated herein. One particularly desirable class of metallic build materials are metallic multi-phase materials. Such multi-phase materials can be any wholly or partially metallic mixture that exhibits a working temperature range in which at least one solid phase and at least one liquid phase co-exist, resulting in a rheology suitable for fused filament fabrication or similar techniques described herein.

The term metal containing multi-phase type material, referred to in shortened form as an MCMP type, or simply an MCMP material, will be used to refer to all of the materials that are about to be described, and any other suitable materials not explicitly mentioned, but which exhibits a working temperature range in which at least one solid phase and at least one liquid phase co-exist, resulting in a rheology suitable for fused filament fabrication or similar techniques described herein. MCMP materials are described more fully in the U.S. application Ser. No. 16/038,057 mentioned and incorporated by reference above.

In one aspect, a MCMP build material may be a metal alloy that exhibits a multi-phase equilibrium between at least one solid and at least one liquid phase. Such a semi-solid state may provide a working temperature range with rheological behavior suitable for use in fused filament fabrication as contemplated herein. For example, the composite may, within the working temperature range, form a non-Newtonian paste or Bingham fluid with a non-zero shear stress at zero shear strain. While the viscous fluid nature of the composite permits extrusion or other similar deposition techniques, this non-Newtonian characteristic can permit the deposited material to retain its shape against the force of gravity so that a printed object can retain a desired form until the composite material cools below a solidus or eutectic temperature of the metallic base.

For example, a composition of a eutectic alloy system, which is not the eutectic composition, may exhibit such a multiphase equilibrium. Compositions within an alloy system with a eutectic may melt over a range of temperatures rather than at a melting point and thus provide a semi-solid state with a mixture of at least one solid and at least one liquid phase that collectively provide rheological behavior suitable for fused filament fabrication or similar additive fabrication techniques. This mixture may be at equilibrium or stable over the timescales of the extrusion process.

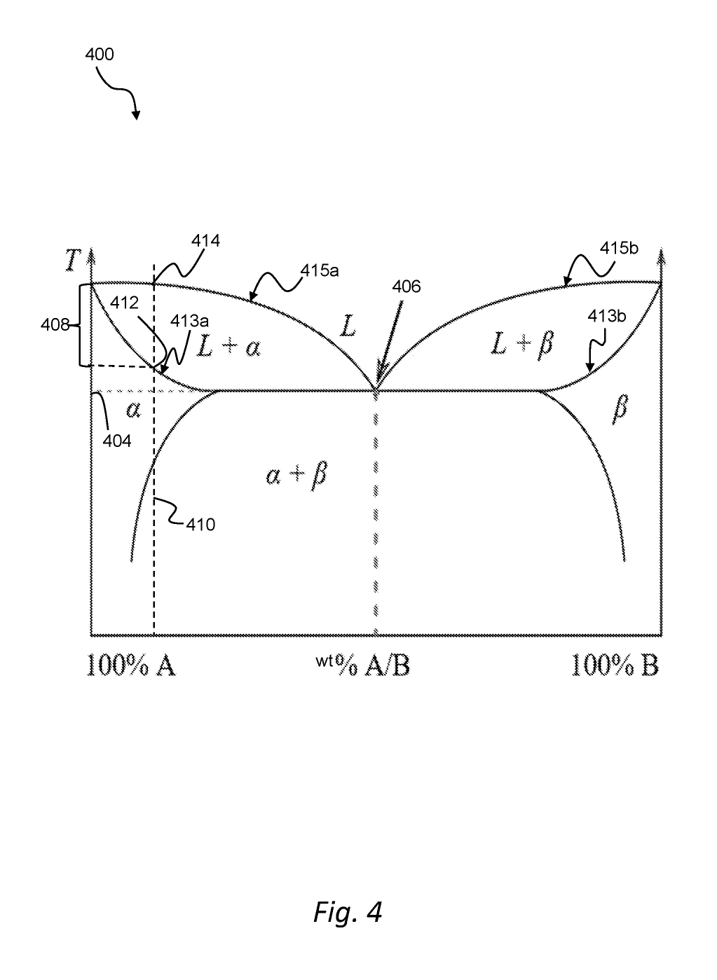

FIG. 4 shows a phase diagram 400 for a simple eutectic alloy system, exhibiting an alloy composition suitable for use as a MCMP build material in the methods and systems described herein. The eutectic composition is the composition present at the vertical dashed line that intersects the point 406. The point 406 is at the intersection of the lines that represent the eutectic composition (vertical dashed) and the eutectic temperature 404. In general, the build material may include an alloy with a working temperature range in which the mixture contains a solid and liquid phase in an equilibrium proportion dependent on temperature. The solid and liquid phases coexist within the temperature and composition combinations within the two bound regions labeled as L+α and L+β, respectively. This notation signifies that within that region, the build material exists as a mixture of a liquid phase L made up of components A and B and a solid phase with a specific crystalline structure. The solid phase is denoted as α, for compositions to the left of the eutectic composition (higher concentrations of component A) and as β for compositions to the right of the eutectic composition (higher concentrations of component B). Where α denotes a solid solution of B in an A matrix and β denotes a solid solution of A in a B matrix. This multi-phase condition usefully increases viscosity of the material above the pure liquid viscosity while in the working temperature range to render the material in a flowable state exhibiting rheological behavior suitable for fused filament fabrication or similar extrusion-based additive manufacturing techniques.

It should be understood that whenever alloy systems are discussed which have two constituents, that is, binary alloy systems, the same concepts will apply to alloy systems with three, four, and any number of constituents. As an example, a quaternary system can also have a eutectic composition.

The alloy composition just described is one instance of a MCMP material of a general class of materials that are suitable for use with present teachings hereof.

In FIG. 4, a phase diagram 400, shows composition and temperature combinations above the liquidus curves 415a and 415b will be a single liquid phase L. When an alloy in a eutectic alloy system solidifies, its components may solidify at different temperatures, resulting in a semi-solid suspension of solid and liquid components prior to full solidification. The working temperature for such an alloy composition is generally a range of temperatures between a lowest and highest melting temperature. In a mixture around the eutectic point 406, the lowest melting temperature (at which this mixture remains partially molten) is the eutectic temperature 404. The highest melting temperature will generally be a function of the percentage of the components A and B. In regions far from the eutectic composition such that the eutectic line terminates, i.e., at the far left or the far right of the phase diagram 400, the lowest melting temperature may be somewhat above the eutectic temperature, e.g., at the solidus temperature of the alloy. The solidus temperatures for different compositions lie upon the solidus curves 413a and 413b, which also are collinear for some of their extent with a horizontal line at the eutectic temperature 404. For example, for a composition in a eutectic alloy system with a very high fraction of material A (as indicated by a dashed vertical line 410), the composition may have a solidus temperature 412 somewhat above the eutectic temperature 404, and a liquidus temperature 414 at the highest liquidus temperature for the composition. Either type of composition, may have a working temperature range 408 including a range of temperatures above a lowest melting temperature (e.g., where the entire system becomes solid) and below a highest melting temperature (e.g., where the entire system becomes liquid) where the composition, or a corresponding metallic build material includes solid and liquid phases in a combination providing a variable, temperature-dependent viscosity and rheological behavior suitable for extrusion. This working temperature range 408 will vary by composition and alloying elements, but may be adapted for a wide range of metal alloys for use in a fused filament fabrication process or the like as contemplated herein.

Another instance of suitable MCMP materials may include compositions within a peritectic alloy system. A composition within a peritectic alloy system may also have a working temperature range with a multi-phase state suitable for use in a fused filament fabrication process.

Generally, a suitable MCMP material alloy system may contain more than one eutectic or more than one peritectic, as well as both eutectics and peritectics, all of which may provide a multi-phase state with a rheology suitable for extrusion. For example, the Al—Cu phase diagram (not reproduced herein) has both a eutectic and a peritectic. In particular the presence of intermediate phases and intermetallic compounds can greatly increase the complexity of metal alloy phase diagrams, resulting in multiple regions within the phase diagram where at least one liquid phase and at least one solid phase coexist in equilibrium. In such systems, there may be a wide range of alloy compositions exhibiting a working temperature range with a multi-phase state suitable for use as a metallic build material in a fused filament fabrication process. All of the foregoing are instances of suitable MCMP materials.

Yet another instance of suitable MCMP materials are isomorphous alloy systems.

More generally, a chemical system may exhibit a multi-phase equilibrium between at least one solid and at least one liquid phase without exhibiting a eutectic or a peritectic phase behavior. The copper-gold system is an example. Such systems may still provide a working temperature range between a solidus and liquidus temperature with a rheology suitable for use in fused filament fabrication process as contemplated herein, and such systems are considered an instance of MCMP materials.

Another instance of suitable MCMP materials include metallic materials using a combination of a metallic base and a high temperature inert second phase, which may constitute a metallic multi-phase material which may be usefully deployed as a build material for fused filament fabrication. For example, U.S. application Ser. No. 15/059,256, filed on Mar. 2, 2016 and incorporated by reference herein in its entirety, describes a variety of such materials. Thus, one useful metallic build material contemplated herein includes a composite formed of a metallic base and a second phase.

Another instance of suitable MCMP build materials includes a metal loaded extrudable composite made up of a combination of a matrix material and metal particles. The matrix material may melt or undergo a glass-to-liquid-transition well below the melting temperature of the metal particles and thus provide a working temperature range in which the viscous fluid nature of the composite permits extrusion or other similar deposition techniques.

Still more generally, describing the overall concept of MCMP materials, they may include any build material with metallic content that provides a useful working temperature range with rheological behavior suitable for heated extrusion and thus may be used as a metallic build material as contemplated herein. Examples have been given above. The limits of this window or range of working temperatures will depend on the type of material (e.g. metal alloy, metallic material with high temperature inert phase, metal-loaded extrudable composites) and the metallic and non-metallic constituents. For metal alloys, such as compositions in eutectic alloy systems, peritectic alloy systems and isomorphous alloy systems, the useful temperature range is typically between a solidus temperature and a liquidus temperature. In this context, the corresponding working temperature range is referred to for simplicity as a working temperature range between a lowest and highest melting temperature. For MCMP build materials with an inert high temperature second phase, the window may begin at any temperature above the melting temperature of the base metallic alloy, and may range up to any temperature where the second phase remains substantially inert within the mixture. For MCMP metal-loaded extrudable composites, the window may begin at any temperature above the glass transition temperature for amorphous matrix materials or above the melting temperature for crystalline matrix materials, and may range up to any temperature where the thermal decomposition of the matrix material remains sufficiently low.

According to the foregoing, the term MCMP build material, as used herein, is intended to refer to any metal-containing build material, which may include elemental or alloyed metallic components, as well as compositions containing other non-metallic components, which may be added for any of a variety of mechanical, rheological, aesthetic, or other purposes. For non-limiting example, non-metallic strengtheners may be added to a metallic material. As another example, a non-metallic material (e.g., plastic, glass, carbon fiber, and so forth) may be imbedded as a support material to reinforce structural integrity of a metallic build material. The presence of a non-metallic support material may be advantageous in many fabrication contexts, such as extended bridging where build material is positioned over large unsupported regions. Moreover, other non-metallic compositions such as sacrificial support materials may be usefully deposited using the systems and methods contemplated herein. All such materials and compositions used in fabricating a metallic object, either as constituents of the metallic object or as supplemental materials used to aid in the fabrication of the metallic object, are intended to fall within the scope of a MCMP build material as contemplated herein, suitable for use with present teachings discussed herein.

Much of the discussion above has centered around alloy systems containing as few as two elements. The present teachings disclosed herein apply to alloy systems with any number of elements. Examples of commercial alloys which are relevant include the following: Zinc die-casting alloys such as Zamak 2, Zamak 3, Zamak 5, Zamak 7. ZA-8, ZA-12, ZA-27 Magnesium die casting alloys such as AZ91. Aluminum casting alloys such as A356, A357, A319, A360, A380. Aluminum wrought alloys such as 6061, 7075.

It is useful to return to a more detailed discussion of apparatus and methods used to treat and build objects with such build materials. FIG. 1 is a block diagram of an additive manufacturing system. In general, the additive manufacturing system may include a three-dimensional printer 101 (or simply printer 101) that deposits a metal, metal alloy, metal composite or the like using fused filament fabrication or any similar process. In general, the printer 101 may include a build material 102 that is propelled by a drive system 104 and heated to an extrudable state by a heating system 106, and then extruded through one or more nozzles 110. By concurrently controlling robotics 108 to position the nozzle(s) along an extrusion path relative to a build plate 114, an object 112 may be fabricated on the build plate 114 which may be situated within a build chamber 116. In general, a control system 118 may manage operation of the printer 101 to fabricate the object 112 according to a three-dimensional model using a fused filament fabrication process or the like.

The build material 102 may be provided in a variety of form factors including, without limitation, any of the form factors described herein or in materials incorporated by reference herein. The build material 102 may be provided, for example, from a hermetically sealed container or the like (e.g., to mitigate passivation), as a continuous feed (e.g., a wire). In one aspect, two build materials 102 may be used concurrently, e.g., through two different nozzles.

The build material 102 may include a metal wire, such as a wire with a diameter of approximately 80 μm, 90 μm, 100 μm, 0.5 mm, 1 mm, 1.25 mm, 1.5 mm, 1.75 mm, 2 mm, 2.25 mm, 2.5 mm, 3 mm, or any other suitable diameter.

The build material 102 may have any shape or size suitable for extrusion in a fused filament fabrication process.

A printer 101 disclosed herein may include a first nozzle 110 for extruding a first material. The printer 101 may also include a second nozzle for extruding a second material with the same or different mechanical, functional, or aesthetic properties useful for fabricating a multi-material object.

A drive system 104 may include any suitable gears, rollers, compression pistons, or the like for continuous or indexed feeding of the build material 102 into the heating system 106.

The heating system 106 may employ a variety of techniques to heat a metallic build material to a temperature within a working temperature range suitable for extrusion. For fused filament fabrication systems as contemplated herein, this is more generally a range of temperatures where a build material exhibits rheological behavior suitable for fused filament fabrication or a similar extrusion-based process. These behaviors are generally appreciated for, e.g., thermoplastics such as ABS or PLA used in fused deposition modeling, however many metallic build materials have similarly suitable behavior, albeit many with greater forces and higher temperatures, for heating, deformation and flow through a nozzle so that they can be deposited onto an object with a force and at a temperature to fuse to an underlying layer. Among other things, this may require a plasticity at elevated temperatures that can be propelled through a nozzle for deposition (at time scales suitable for three-dimensional printing), and a rigidity at lower temperatures that can be used to transfer force downstream in a feed path to a nozzle bore or reservoir where the build material can be heated into a flowable state and forced out of a nozzle.

Any heating system 106 or combination of heating systems suitable for maintaining a corresponding working temperature range in the build material 102 where and as needed to drive the build material 102 to and through the nozzle 110 may be suitably employed as a heating system 106 as contemplated herein. Particularly useful nozzles and methods of using such nozzles having mechanisms for both heating (adding thermal power to) the nozzle outlet and cooling its inlet, and even the opposite (providing thermal power to the inlet and removing thermal power from (cooling) the nozzle outlet are disclosed in U.S. patent application Ser. No. 16/035,296, mentioned and incorporated by reference, above.

The robotics 108 may include any robotic components or systems suitable for moving the nozzles 110 in a three-dimensional path relative to the build plate 114 while extruding build material 102 to fabricate the object 112 from the build material 102 according to a computerized model of the object. A variety of robotics systems are known in the art and suitable for use as the robotics 108 contemplated herein. For example, the robotics 108 may include a Cartesian coordinate robot or x-y-z robotic system employing a number of linear controls to move independently in the x-axis, the y-axis, and the z-axis within the build chamber 116. Delta robots may also or instead be usefully employed. Other configurations such as double or triple delta robots can increase range of motion using multiple linkages. More generally, any robotics suitable for controlled positioning of a nozzle 110 relative to the build plate 114 may be usefully employed, including any mechanism or combination of mechanisms suitable for actuation, manipulation, locomotion, and the like within the build chamber 116.

The robotics 108 may position the nozzle 110 relative to the build plate 114 by controlling movement of one or more of the nozzle 110 and the build plate 114. The object 112 may be any object suitable for fabrication using the techniques contemplated herein. The build plate 114 may be formed of any surface or substance suitable for receiving deposited metal or other materials from the nozzles 110.

The build plate 114 may be movable within the build chamber 116, e.g., by a positioning assembly (e.g., the same robotics 108 that position the nozzle 110 or different robotics). For example, the build plate 114 may be movable along a z-axis (e.g., up and down-toward and away from the nozzle 110), or along an x-y plane (e.g., side to side, for instance in a pattern that forms the tool path or that works in conjunction with movement of the nozzle 110 to form the tool path for fabricating the object 112), or some combination of these. In an aspect, the build plate 114 is rotatable. The build plate 114 may include a temperature control system for maintaining or adjusting a temperature of at least a portion of the build plate 114.

In general, an optional build chamber 116 houses the build plate 114 and the nozzle 110, and maintains a build environment suitable for fabricating the object 112 on the build plate 114 from the build material 102.

The printer 101 may include a vacuum pump 124 coupled to the build chamber 116 and operable to create a vacuum within the build chamber 116. The build chamber 116 may form an environmentally sealed chamber so that it can be evacuated with the vacuum pump 124 or any similar device in order to provide a vacuum environment for fabrication. The environmentally sealed build chamber 116 can be purged of oxygen, or filled with one or more inert gases in a controlled manner to provide a stable build environment. Thus, for example, the build chamber 116 may be substantially filled with one or more inert gases such as argon or any other gases that do not interact significantly with heated metallic build materials 102 used by the printer 101.

In general, a control system 118 may include a controller or the like configured to control operation of the printer 101. The control system 118 may be operable to control the components of the additive manufacturing system 100, such as the nozzle 110, the build plate 114, the robotics 108, the various temperature and pressure control systems, and any other components of the additive manufacturing system 100 described herein to fabricate the object 112 from the build material 102 according to build path instructions 122 based on a three-dimensional model or any other computerized model describing the object 112 or objects to be fabricated. The control system 118 may include any combination of software and/or processing circuitry suitable for controlling the various components of the additive manufacturing system 100 described herein including without limitation microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and the like. The log of process history 140 is explained below, but generally, it is a logged record in which relevant data related to the history of the process is recorded.

In general, build path instructions 122 or other computerized model of the object 112 may be stored in a database 120 such as a local memory of a computing device used as the control system 118, or a remote database accessible through a server or other remote resource, or in any other computer-readable medium accessible to the control system 118. The control system 118 may retrieve particular build path instructions 122 in response to user input, and generate machine-ready instructions for execution by the printer 101 to fabricate the corresponding object 112.

In operation, to prepare for the additive manufacturing of an object 112, a design for the object 112 may first be provided to a computing device 164. The design may be build path instructions 122 of a three-dimensional model included in a CAD file or the like.

A 3D representation of an object or objects to be additively manufactured may be represented as a set of build path instructions. Within the build path instructions, it is possible to define build path segments or equivalently path segments or equivalently paths. Every path segments has (possibly coinciding) a starting point and an ending point and in most cases build material is deposited in some fashion between them. Path segments may be curvilinear. There are additional motions in the instruction set which do not command build material deposition. For example, these may include rapid traversals from one point to another, or retractions and priming of the build material with the nozzle. Often, the instruction set may be divided into layers, where a layer is a collection of paths segments deposited in the same plane.

The computing device 164 may include the control system 118 as described herein or a component of the control system 118. The computing device 164 may also or instead supplement or be provided in lieu of the control system 118. Thus, unless explicitly stated to the contrary or otherwise clear from the context, any of the functions of the computing device 164 may be performed by the control system 118 and vice-versa. In another aspect, the computing device 164 is in communication with or otherwise coupled to the control system 118, e.g., through a network 160.

The computing device 164 (and the control system 118) may include a processor 166 and a memory 168 to perform the functions and processing tasks related to management of the additive manufacturing system 100 as described herein.

One or more ultrasound transducers 130 or similar vibration components may be usefully deployed at a variety of locations within the printer 101. As discussed below, a nozzle service region 188 is spaced away from the object build region 186 where the object is fabricated. The nozzle service region is where at least some service operations are conducted. It may include one or more cameras 150 or other optical or visual devices, other sensors 170, waste material receptacles 128, additional heating and cooling apparatus 126, as well as any items or supplies that may be used to service the nozzle and other parts of the device.

FIG. 3 shows an extruder 300 for a three-dimensional printer. In general, the extruder 300 may include a nozzle 302, a nozzle bore 304, a heating system 306, and a drive system 308 such as any of the systems described herein, or any other devices or combination of devices suitable for a printer that fabricates an object from a computerized model using a fused filament fabrication process and a metallic build material as contemplated herein. In general, the extruder 300 may receive a build material 310 from a source 312, such as any of the build materials and sources described herein, and advance the build material 310 along a feed path (indicated generally by an arrow 314) toward an opening 316 of the nozzle 302 for deposition on a build plate 318 or other suitable surface. The term build material is used herein interchangeably to refer to metallic build material, species and combinations of metallic build materials, or any other build materials. As such, references to build material 310 should be understood to include metallic build materials, or multi-phase metallic build materials or any of the other build material or combination of build materials described herein, under specific conditions, unless a more specific meaning is provided or otherwise clear from the context.

The nozzle 302 may be any nozzle suitable for the temperatures and mechanical forces required for the build material 310. For extrusion of metallic build materials, portions of the nozzle 302 (and the nozzle bore 304) may be formed of high-temperature materials such as sapphire, alumina, aluminum nitride, graphite, boron nitride or quartz, which provide a substantial margin of safety for system components.

The nozzle bore 304 may be any chamber or the like suitable for heating the build material 310, and may include an inlet 305 to receive a build material 310 from the source 312. The nozzle 302 may also include an outlet 316 that provides an exit path for the build material 310 to exit the nozzle bore 304 along the feed path 314 where, for example, the build material 310 may be deposited in a segment (also referred to herein and in the industry as a road, bead, or line) on the build plate 318. The inside dimensions of the nozzle bore may be larger than the outside dimensions of the incoming build material, and thus could be said to have some amount of clearance or extra volume with respect the build material. It should also be noted that the nozzle bore may take a wide array of geometries and cross-sections and need not be uniform along its length. For example, it may include diverging sections, converging sections, straight sections, and non-cylindrical sections. Subsequent layers of lines are deposited upon an earlier layer 392. The layer presently being deposited as the top layer 390 has an exposed upper surface 372, upon which the nest to be deposited layer will be deposited.

The heating system 306 may employ any of the heating devices or techniques described herein. It will be understood that the heating system 306 may also or instead be configured to provide additional thermal control, such as by locally heating the build material 310 where it exits the nozzle 302 or fuses with a second layer 392 of previously deposited material, or by heating a build chamber or other build environment where the nozzle 302 is fabricating an object. The temperature of the nozzle 302 may be measured with one or more temperature measuring devices 340. Optionally, forced gas cooling 362 may be applied near the nozzle inlet. An auxiliary heater (not shown) may be provided relatively close to the inlet 305, for times when it may be desired to heat add thermal power to the nozzle near to the inlet.

The drive system 308 may be any drive system operable to mechanically engage the build material 310 in solid form and advance the build material 310 from the source 312 into the nozzle bore 304 with sufficient force to extrude the build material 310, while at a temperature within the working temperature range, through the opening 316 in the nozzle 302. In general, the drive system 308 may engage the build material 310 while at a temperature below the working temperature range, e.g., in solid form, or at a temperature below a bottom of the working temperature range where the build material 310 is more pliable but still sufficiently rigid to support extrusion loads and translate a driving force from the drive system 308 through the build material 310 to extrude the heated build material in the nozzle bore 304.

A sensor, such as a load cell 328, or a torque sensor 309, may be coupled to the drive system 308, to sense the load on the drive system. This can be useful, for instance, to determine whether any blockages or other impediments to driving the build material may be occurring. In one embodiment, the drive assembly is allowed to pivot about point 311 and the load cell 328 provides the reaction force. Additionally, a sensor 329 can be provided that measures the force exerted by build material 310 within and exiting the nozzle outlet 316 upon the nozzle 302. For instance, a load cell 329 can measure the force of the build material pushing on the entire nozzle 302. In one embodiment, the nozzle assembly is allowed to pivot about point 313 and the load cell 329 provides the reaction force. Other such devices that can be used to determine whether a blockage or impediment has arisen are mentioned and discussed below.

Alternatively, a torque sensor can be included within the drive mechanism to sense the torque on the driving apparatus, such as wheels or gears. The current that any motor used to power the drive system is related to the force that the drive system encounters. Therefore, the current drawn by the drive motor 344 can be monitored via sensor 342, with an increase in current indicating an increase in power needed to drive the build material into the nozzle inlet and thereby inferring the extrusion force. The motor 344 is mechanically engaged with build material drive system 308.

As discussed below, the forces measured by the various sensors can be compared, or combined, or otherwise analyzed to assess whether or not a flow artifact is present or forming.

A camera or other optical sensor, such as 352 can be provided near to the nozzle inlet 305, where it may observe the geometrical condition of the build material as it is being driven into the nozzle. For instance, if the build material is in the form of a wire, and if the wire buckles, that may indicate that there is blockage or some other impediment to the flow of build material through the extruder 300. Alternatively, if the diameter of the build material immediately adjacent the inlet 305 to the nozzle increases, in a phenomenon that may be referred to a mushrooming, that might indicate that the softened build material is deforming, because there is an impediment to it proceeding into the nozzle bore 304.

There can also be some form of an electrical or mechanical or electromechanical switch that trips at a force set point to indicate that the force has exceeded such a set point and thus that a flow artifact is forming or present. For instance, a clutch 303 may be provided on the drive system 308 itself. An alternative or additional mechanism that limits the force that the drive system can apply is a properly tuned bi-stable flexure or over-center mechanism. In another embodiment, a properly tuned permanent magnet or electromagnetic or mechanical latch mechanism may break free. In these embodiments, upon exceeding a predefined force, a portion of the feeding system moves relative to the nozzle to an idle state. The device may then be passively or actively reset during the nozzle service routine to guard against future high force events.

It may be beneficial to combine any of these force limiting mechanisms with an appropriate sensor, such as a limit switch, hall effect sensor, a position detecting sensor or the like, to sense whether the limiting device has been tripped or activated, and to then indicate that a flow artifact is forming or has formed such that the controller may take the appropriate action such as ceasing the extrusion of build material, decelerating the robotics and logging the interrupt position, as will be discussed.

The extruder 300 may also include a controller 360, for controlling various components of the extruder, including the cooling 362, heating 306 and taking various inputs including temperatures 340, forces 328 329, sensor 352 and sensor 353.

Unlike thermoplastics conventionally used in fused filament fabrication, metallic build materials are highly thermally conductive. As a result, high nozzle temperatures can contribute to elevated temperatures in the drive system 308. Thus, in one aspect, a lower limit of the working temperature range for the nozzle bore 304 and nozzle 302 may be any temperature within the temperature ranges described above that is also above a temperature of the build material 310 where it engages the drive system 308, thus providing a first temperature range for driving the build material 310 and a second temperature range greater than the first temperature range for extruding the build material 310. Or stated alternatively and consistent with the previously discussed working temperature ranges, the build material 310 may typically be maintained within the working temperature range while extruding and below the working temperature range while engaged with the drive system 308, however, in some embodiments the build material 310 may be maintained within the working temperature when engaged with the drive system 308 and when subsequently extruded from by the nozzle 302. All such temperature profiles consistent with extrusion of metallic build materials as contemplated herein may be suitably employed. While illustrated as a gear, it will be understood that the drive system 308 may include any of the drive chain components described herein, and the build material 310 may be in any suitable, corresponding form factor.

As noted above, a printer may include two or more nozzles and extruders for supplying multiple build and support materials or the like. Thus, the extruder 300 may be a second extruder for extruding a supplemental build material.

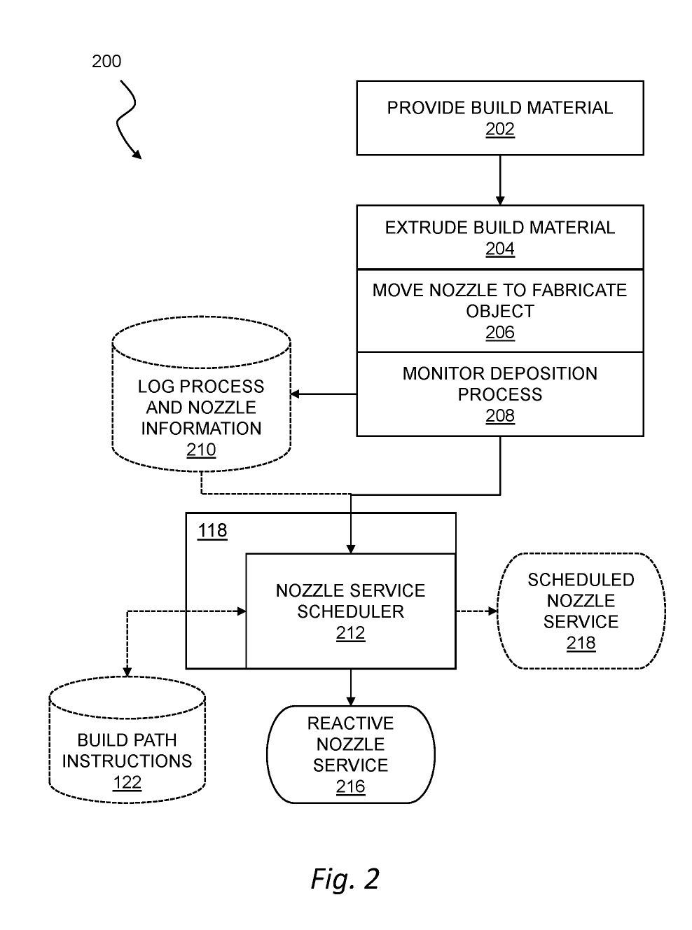

FIG. 2 shows schematically, in flow chart form, the steps of a method 200 for operating a printer in a three-dimensional fabrication of an object. As shown in step 202, the method 200 may begin with providing a build material such as any of the build materials described herein to an extruder. It is beneficial to monitor 208 feeding and/or deposition of the build material, for instance with a camera 150 (FIG. 1) or 352 (FIG. 3), or a force sensor 328 (FIG. 3), as discussed above. Monitoring of build material condition is discussed in general in U.S. application Ser. No. 16/038,057, mentioned and incorporated by reference, above. Monitoring 208 may begin, generally, even before any build material is fed into the nozzle or extruded 204. In this way, any problems that are present from the very beginning of printing would be detected.

At steady state, substantially simultaneously, build material is fed into the nozzle inlet and extruded 204 from the nozzle outlet, and the nozzle outlet is moved 206, relative to the build plate, to deposit segments of extruded build material, to fabricate an object. These steps are conducted over and over again until the object is completed, or service is taken, as discussed below. It should be understood that the simultaneity shown if FIG. 2 is at steady state extrusion of build material.

Commencement of a printing operation is generally associated with substantially simultaneously establishing the extrusion nozzle at an operating temperature, feeding build material into the nozzle with a drive system, extruding build material from the nozzle and moving the nozzle relative to the build plate along the build path. However, it is understood that these processes may not all always be necessary, and may not all occur exactly at the same time. For instance, depending on the nozzle geometry and the amount of build material already contained within the nozzle, feeding the nozzle naturally precedes extrusion of the material from the nozzle by some time. Similarly, establishing a nozzle temperature may require a duration of time, as heat is transferred to the nozzle from a heating system. Moreover, in certain situations it may be desirable to temporarily feed and extrude build material without moving the nozzle relative to the build bed along the build path. And vice versa, in some cases it may be beneficial to move the nozzle relative to the build bed along the build path without feeding and extruding build material. Similarly, starting up and stopping extrusion may sequence these three elements in different orders. For instance, at start up, before any material is within the extruder body, it is impossible to feed build material and extrude simultaneously, because there is nothing in the nozzle to extrude. Similarly, it would be pointless to move the nozzle at that time.

Considering first an increased force required to feed build material into the nozzle, a sensor can be used to monitor 208 a deposition parameter, such as force on the drive system 308, measured by load cell 328 (FIG. 3). Such a sensor detection can constitute an error condition and the system can monitor deposition 208 for such an error, and then initiate service, as discussed below.

The same parameter or parameters that are monitored during the deposition process may be logged 210 along with other information regarding the usage of the nozzle. The nozzle service scheduler 212, which is a subset of the controller 118 shown in FIG. 1, may take information about the deposition process and optionally the logged information 210 and build path instructions 122 (also shown in FIG. 1) as well as internal logic and predefined values into account to create reactive nozzle service events 216 and scheduled nozzle service events 218. The controller 118 may modify the build path instructions 122 as required, for instance, by splitting a path segment into one or more path segments.

The foregoing has described generally 3D printing with build materials that are MCMP, and also general aspects of 3D printing with typical hardware. Below will be described methods to detect, anticipate, mitigate and otherwise reduce difficulties caused by build material clogging or jamming or clumping or otherwise failing to flow freely within and through and out from the nozzle. Various methods to service the nozzles, or service them or clear or reduce any such clogs or flow artifacts are discussed.

The present teachings described herein include methods for additive fabrication using MCMP build materials, which can be prone to flow artifacts and impediments, such as clogging, flow reductions, clumping, etc. Techniques and hardware described herein relate to and include but are not limited to monitoring build material feed and extrusion and processing parameters, such as forces upon and imposed by the build material, its appearance, shape, conformation, both entering and exiting from a nozzle, evaluating anticipatory and/or reactive criteria based upon both measured parameters and also elapsed time, quantities of material extruded, and other criteria. In general, error conditions, discussed below, are evaluated and may be used to anticipate and thus mitigate nozzle clogging and also to identify incipient and developed clogs, and thus to facilitate extrusion of metallic build materials to a highly continuous degree. In addition to mitigating the formation of nozzle clogs, methods and apparatus disclosed herein may also be used to clear existing clogs or otherwise address evolving clogs in a nozzle or elsewhere within a flow path through an extruder. These methods can be used alone, or in combination with each other.

Nozzles used for the FFF of metallic build materials are prone to clogging or jamming. The mechanisms and reasons for clog or jam formation are complicated and are not fully understood. However, based on extensive experience with MCMP build materials in a variety of circumstances, it is believed that the following reasonably explains relevant phenomena, although this explanation is provided for information purposes only, and is not intended to limit the generality of any of the claims hereto. In many cases, accumulation of solid phase material at undesirable locations within the nozzle can contribute to clog formation and eventually result in clogs. Accumulation of high melting point, relatively large particles of foreign species inside the nozzle may contribute to clog formation. Such species can be oxide particles originating from a residual oxide layer on the incoming build material or formed inside the nozzle during the extrusion process in an oxygen rich environment. The presence of other high melting point impurities in the build material may also contribute to the buildup of such particles. The accumulated solid phase material may also originate from the solid phase of the multi-phase metal build material itself. For instance, a liquid phase of the multi-phase metal build material may be extruded preferentially over a solid phase and the solid phase may then remain in and build up in the nozzle. Moreover, agglomeration of solid phase material during the extrusion process may result in the growth of increasingly larger and larger solid particle over time, which may then clog the nozzle outlet. Some multi-phase build materials may also undergo Ostwald ripening, which may result in an increase in the average solid particle size over time. Larger particles are more likely to build up in the nozzle and form clogs. Another clog mechanism is solidification of liquid phase material in areas of the nozzle that are at a temperature below the working temperature range of the build material, and thus pockets of solidification occur. Another mechanism that can result in accumulation of solid phase material can occur during extended extrusion at high build material feed rates. In this case the nozzle may not be able to supply enough thermal power to heat up the feedstock material to its desired extrusion temperature. Since the fraction of solid phase in many multi-phase metal build materials depends strongly on temperature, such an unintentional reduction in extrusion temperature can significantly increase the solid fraction in the multi-phase material within the nozzle and thus lead to increased buildup of a solid phase in the nozzle. Furthermore, the buildup of foreign phase materials (such as oxides, iron-containing intermetallics, or any other materials that are not intended to be present, may impact the effective heat transfer coefficient between the inner surface of the nozzle and the contained and flowing build material. For example, if a layer of oxide builds up on a portion of the walls, due to the dramatically reduced thermal conductivity of the oxide when compared to that of the build material, the build material temperature upon exiting the nozzle may be lower than expected. In the extreme case, the rheological behavior of the extrudate at this temperature may not be conducive to FFF or even extrudable.

In general, the frequency of clogging or jamming events is substantially higher than those in traditional single phase thermoplastic FFF. Furthermore, the frequency of clogging or jamming events may be sufficiently high to occur one or more times during the fabrication of an average object. Therefore, strategies may be employed to monitor, predict and automatically remediate any clogging or jamming events that may occur during a print.

MCMPs pose particular challenges when they are processed in a manner similar to FFF. There are many factors that make processing MCMPs challenging; several factors are presented below. MCMPs often have high thermal conductivities, specific heats and thermal diffusivities and thus may pose particular temperature control challenges. Additionally, for those materials operating in a multi-phase region of their alloying elements, the effective viscosity of the fluid is strongly a function of solid phase content and its morphology. The percent solid phase may be quite sensitive to temperature. Furthermore, many of these materials may exhibit complex rheological behaviors, such as thixotropy. Another concern is the reactivity of molten metals, which are prone to forming oxides in an oxygen containing environment. Some MCMPs contain elements that are self-passivating, and so a layer of oxide may exist on the build material itself before extrusion. These oxides are typically of very high melting point (well above the working temperature range for the MCMP) and may have much lower thermal conductivity. This oxide may then enter the nozzle, which may have negative repercussions if it is not expelled from the nozzle. For those materials that have a molten metal element, the viscosity of the liquid phase is typically very low (several orders of magnitude less than the viscosities of materials typically processed in FFF), yet the liquid phase must entrain the solid phase particles to achieve the requisite effective (combined) viscosity. These two phases should not segregate from one another, as this would lead to a buildup of solid particles in one spatial location and a relatively high concentration of the liquid phase in another spatial location. This has many negative implications for the flow of the MCMP material when in its multi-phase state. For instance, for a given material in a particular condition, it is understood that below a certain flow velocity, the liquid phase has the propensity to segregate from the solid. Additionally, many solid phase particles undergo agglomeration phenomena and Ostwald ripening, causing their size to increase with dwell time within the nozzle. Furthermore, these materials in their multi-phase state may be sensitive to strain rate and pressure gradients within the nozzle. In summary, MCMPs may clog or jam when extruded through a nozzle. Some of these clogging or jamming mechanisms are described in more detail later. The anti-clogging techniques described herein may make use of some of the properties of MCMPs or traits of the printer's hardware system in order to mitigate the clogging or jamming when processing these materials.

In general, methods disclosed herein and the hardware that facilitates and implements them, involve paying attention to printing or extrusion parameters, monitoring in some manner for problematic parameter values, and then conducting nozzle service. The service can be conducted on a schedule that is fixed (e.g. after a fixed period of time, or a fixed amount of material extruded). Or, the schedule can be varied. The variation can be based on combinations or functions of a plurality of factors, such as, a function of two parameters, such as duration of a printing session and volume printed during a unit of time. A varied schedule can also be changed based on more complicated occurrences, such as the number of service events in a unit of time, or extrapolations of measured parameters over time that indicate a problem may arise relatively soon. Or, service can be unscheduled, and instead, responsive to a measured parameter value or values.

It is helpful consider two conceptually related classes of conditions; anticipatory conditions and error conditions. As used herein, anticipatory conditions are based on a variety of circumstances, which experience or theory has shown indicate that the likelihood of a clogging or other disruptive event is increasing, or at a level that warrants anticipatory action to avoid disruption from such an event. As used herein, error conditions are based on measurement of parameters, such as the force upon the build material as it is driven into the nozzle, or the visual appearance of the extruded build material, or some other measured or observed phenomena, which also either indicates that a clog has formed, is forming, or is likely to form soon enough in the future that service is warranted.

In one aspect, as discussed above, a three dimensional printing system continuously monitors 208 matters to determine whether any anticipatory or error conditions have arisen, anticipatory conditions arise at somewhat predictable or anticipatable moments, and, as such service can be taken before extrusion of a line segment begins. Thus, such services are referred to herein as anticipatory nozzle services. Error conditions arise at less predictable, or unpredictable moments, and thus, it is sometimes most beneficial, if possible, that service be taken immediately after they happen, even during and thus interrupting the printing of a path segment. Thus, services in response to error conditions are generally referred to herein as reactive nozzle services.

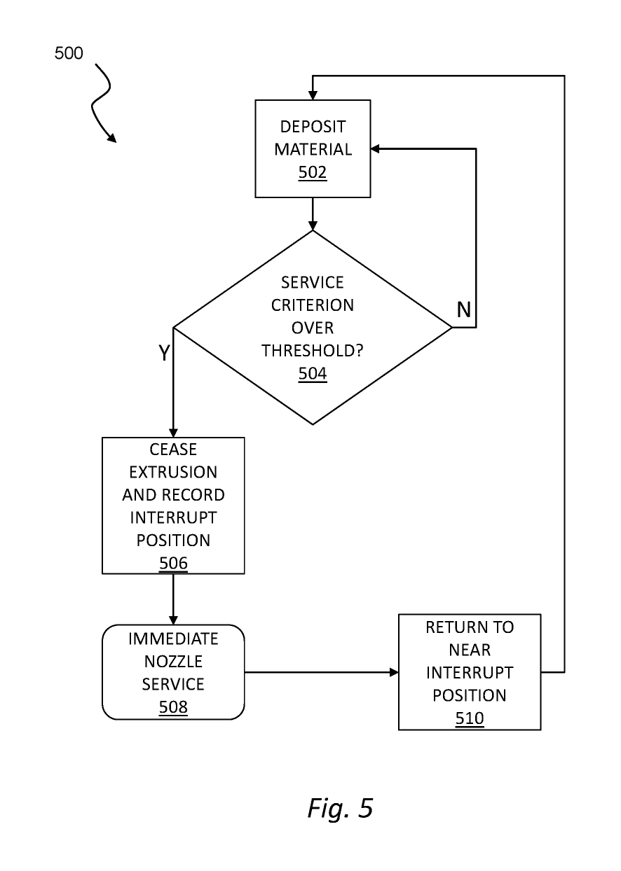

Nozzle service may occur when an error condition is detected, in reaction to a process signal, as mentioned briefly above and as discussed in more detail below, and in connection with FIG. 5. Or nozzle service may occur in response to conditions referred to herein as anticipatory conditions, on a fixed schedule, or on a schedule that adapts to the history or behavior of the system, through user input, or any combination of the aforementioned. Anticipatory conditions that can be planned for, and the resultant anticipatory services take place before a path segment is printed. Conversely, error conditions and their remedial reactive services occur at unplanned times. Thus, anticipatory conditions are discussed first in the following discussion. However, it should be understood that force monitoring steps and routines that support detection of error conditions occur during all of the deposition steps discussed, and is ongoing, and begins simultaneously with consideration by the controller of whether an anticipatory condition has arisen. Force monitoring routines are discussed in more detail below, in connection with error conditions.

Ideally, an operating window can be defined, such that, based upon knowledge of the process, an error condition is statistically unlikely to occur before the end of the operating window, and thus uninterrupted operation will likely continue over the course of the window. This size of the processing window (measured by the appropriate variable, such as time, length of material, mass of material, etc.) may be viewed as an expected value. This knowledge may be experimental or model-based (such as a Markov chain) or a combination thereof. By way of example, if there is a 90% confidence interval that the printer should extrude a length of 20 m of build material without an error condition, then the processing window may be set to 20 m. This is only an example—different confidence intervals, statistical methods, and metrics may be used to define the operating window.

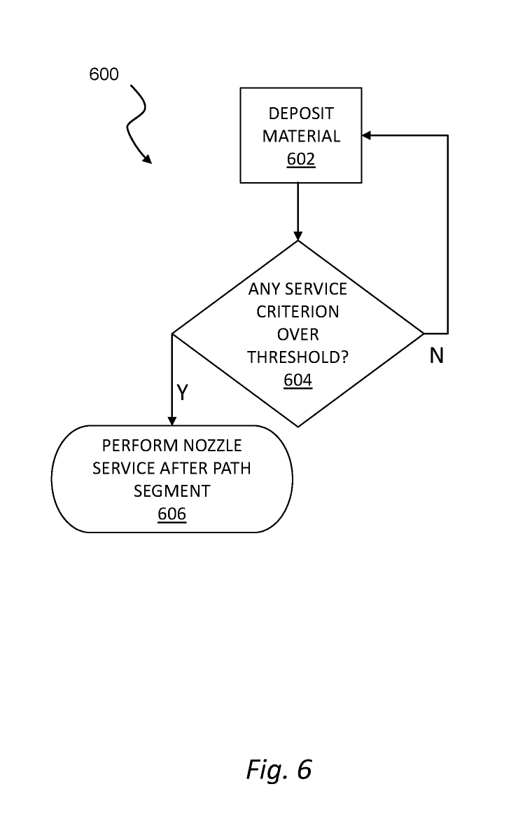

Anticipatory nozzle service may be performed on a schedule based upon process quantities, such as but not limited to: mass of extrudate deposited, time elapsed, some function of the monitored extrusion force versus time or distance (for example, the cumulative integral of the extrusion) or number of path segments printed. The controller 118 or nozzle service scheduler 212 can be programmed to keep track, to count, the passage of any of the process information upon which service scheduling is based, such as length of a period of time, distance or mass or volume of extruded material, using a service criterion. As shown in FIG. 6, which shows schematically a set of steps that the controller conducts to perform a schedule based nozzle service routine 600, the controller directs the system to deposit 602 material to build an object. While doing so, the controller queries 604 whether any service criterion counter is over its threshold. If not, the system branches to 602 and continues to deposit material. If yes, the system branches to 606 to perform a nozzle service after the completion of the current path segment. This process repeats as described. A weighted metric of the aforementioned quantities and others may instead be used as a criterion.

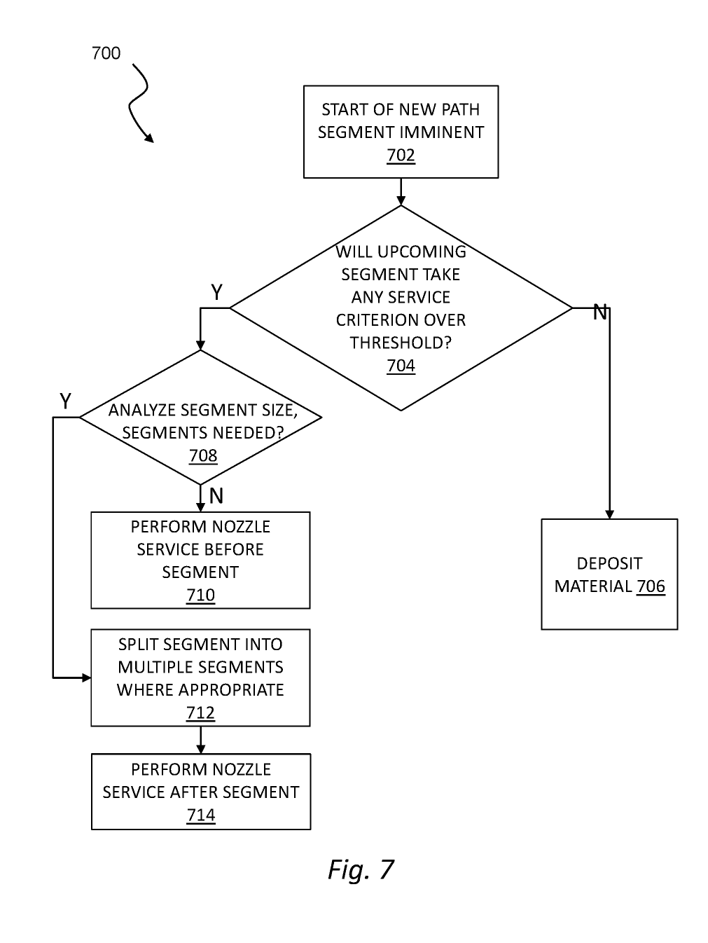

As an extension, the nozzle scheduler may use information regarding the upcoming path segments to make a more informed decision as to when to perform the next anticipatory nozzle service. Ideally, nozzle service occurs before, or between path segments and not during a path segment. As shown in flowchart form in FIG. 7, the method 700 entails a set of steps that the controller conducts to perform a schedule based nozzle service routine that looks ahead. The method 700 begins 702 when the start of a new segment of the build path is imminent. The nozzle service schedule queries 704 if the upcoming path segment would take any of the nozzle service criteria over their respective thresholds prior to commencing the upcoming segment. If yes, the controller may then make a determination 708, depending on the segment size, whether to perform nozzle service before commencing the segment 710, after completing the segment 714, or whether the segment should be split 712 into multiple segments and nozzle service performed after completing one of the shorter segments, which is essentially a portion of the original segment. In this way, the nozzle service may be more accurately placed, per the intended schedule. For example, in the case of a long upcoming path segment, where one or more of the service criteria are expected to be reached, it may be best to artificially split 712 the path segment into two or more shorter path segments, to allow for more accurately placed scheduled nozzle service actions. In another case the nozzle service may conservatively be performed 710 prior to printing the segment. In yet another case the service is not scheduled 714 until after the path segment is printed, despite the fact that one or more nozzle service criteria would have exceeded their respective threshold values by the completion of the path. This last mentioned option 714 is the least conservative approach, but may be desirable if the nozzle service criteria are reached very near to the end of the path segment. If the query 704 whether the upcoming segment will take any service criterion over a threshold returns a no, the segment is deposited normally 706 without a scheduled nozzle service.

The foregoing has briefly mentioned error conditions as those conditions arising based on evaluating a measured parameter. Instances of such measured parameters and types of error conditions are discussed below.

Force monitoring steps 203 (FIG. 2) occur during all deposition steps (and may even be conducted during build material deposition undertaken during nozzle service, such as is discussed below). Monitoring 203 other aspects of deposition, such as visually monitoring aspects of the build material, as discussed, and any other deposition quality monitoring modes may also occur during all deposition steps. Furthermore, the combination of sensor monitoring sample rate, any filtering that may be used and value comparison algorithms should beneficially be able to respond to the most rapid error condition expected to occur with the current system and operating conditions. For example, if a clog may manifest over the course of 10 ms, then a sample rate of at least 10 ms and preferably 5 ms and more preferably 2 ms may be used. By responding sufficiently quickly to a high force event, the feedstock is protected against excessive plastic deformation, which may complicate or compromise further advancement or retraction of the build material, or pose future challenges during deposition (for example, binding in the nozzle bore or volumetric non-uniformity).

Alternatively, a preset value for a force limit may be set through electromechanical means, such as through a clutch 303 (FIG. 3) in the feeder drive system 308, a bi-stable flexure, over-center mechanism, or other means of limiting torque or force known in the art, combined with an appropriate sensor such as a limit switch, hall effect sensor, position detecting sensor or the like to sense whether the limiting device has been tripped, as discussed above. If measuring the current needed by the drive mechanism 308, surpassing a current limit could be used analogously. These methods do not require continuously monitoring the build material feed force, but allow for the system to react to a high force event.

Whether the magnitude of force is measured continuously, or whether force is monitored more rudimentarily for whether it has exceeded a limit, such as a maximum, there is a maximum force that the build material being fed into the nozzle can withstand. Exceeding the maximum force may cause excessive elastic deformation or plastic deformation of the build material, prohibiting further advancement into and through the nozzle. Many factors may determine the maximum force, including: the temperature de-rated compressive yield strength of the build material, cross-sectional geometry, axial temperature profile, or critical load for column buckling under the appropriate end conditions and constraints. The maximum force may instead be limited not by the build material itself, but by the mechanical or electrical limitations of the build material drive (feeder) mechanism. In either case, there exists an upper bound on the permissible feed force. Reasons for increased feed force may include: buildup of foreign phase material within the nozzle, segregation of phases within the nozzle, incorrect nozzle temperature, or excessive back-pressure. It is beneficial to establish an upper limit on the build material feed force, set slightly below the true maximum force, and strive to avoid exceeding this maximum at all times during the printing process.

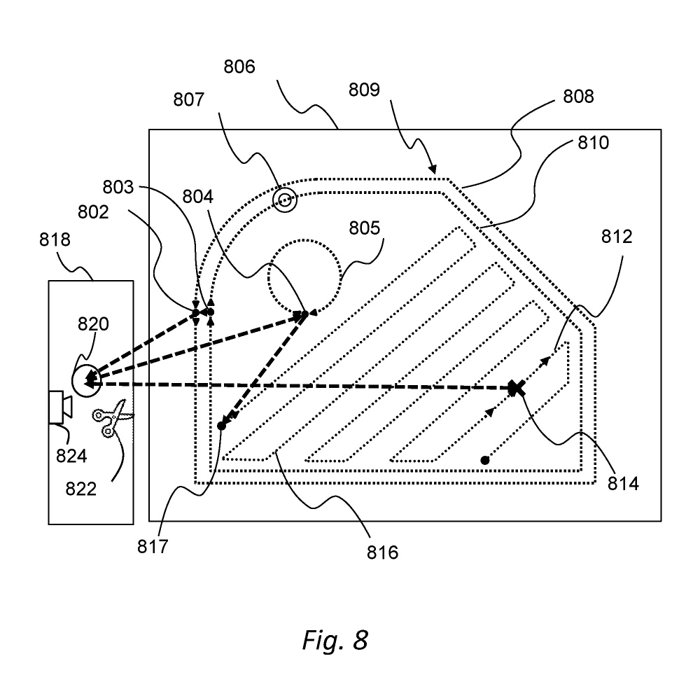

FIG. 8 shows a schematic of the plan view of the printer fabricating an object. The relatively thinner and dotted lines indicate the toolpaths that the nozzle tip traverses while depositing build material. The relatively thicker, and dashed lines represent some of the motions that the nozzle tip performs without depositing build material. The arrows indicate the direction of movement along the potentially curvilinear path segments. The object 809 is created layer-wise atop the build platform 806. The layer-wise instruction set for an object created via FFF may be further divided by path segment type, based upon its geometry. For example, a path segment may form part of the perimeter of the object, or may be completely contained within the shell of the object and be termed infill.

Whether nozzle service is anticipatory or reactive, nozzle service generally involves stopping extruding 204 the build material, and stopping moving 206 nozzle by the robotics, followed by a relative motion of the nozzle 807 away from the object 809 being fabricated, and, as shown in FIG. 8, to a service area 818. In this way, any material ejected from the nozzle during the service does not form part of or foul the printed object or objects 809.

When printing with gravity oriented in the same direction as the build material exits the nozzle, this may require moving the nozzle away from the vertical projection of the extent of the object, (for instance to the left or right, up or down, as shown in FIG. 8) or providing additional mechanisms for catching the extrudate, such that it does not impinge upon, fuse to or otherwise interfere with the printed object 809. The nozzle 807 may move to a predetermined location or set of locations known as nozzle service locations, or, within a general nozzle service area 818 as shown in FIG. 8. Such locations may exist away from any object geometry and offer such auxiliary equipment as material waste trays, wire cutters 822, auxiliary heating and cooling elements, sensors, including cameras 824, additional material feeders, stationary or moveable brushes or bristles or wipers, waste buckets or trays to catch the waste build material which is ejected from the nozzle during the nozzle service or gas jets (shown generically as 820) which may facilitate or augment the nozzle servicing techniques described herein. Upon completion of the nozzle servicing activities, the nozzle 807 may return to the point where the deposition was ceased. The controlled cessation of build material extrusion and subsequent resumption of build material deposition can be performed in a largely seamless manner. In other words, the potential interruption in a deposited segment may be minimally apparent as printing continues, and in the finished object.

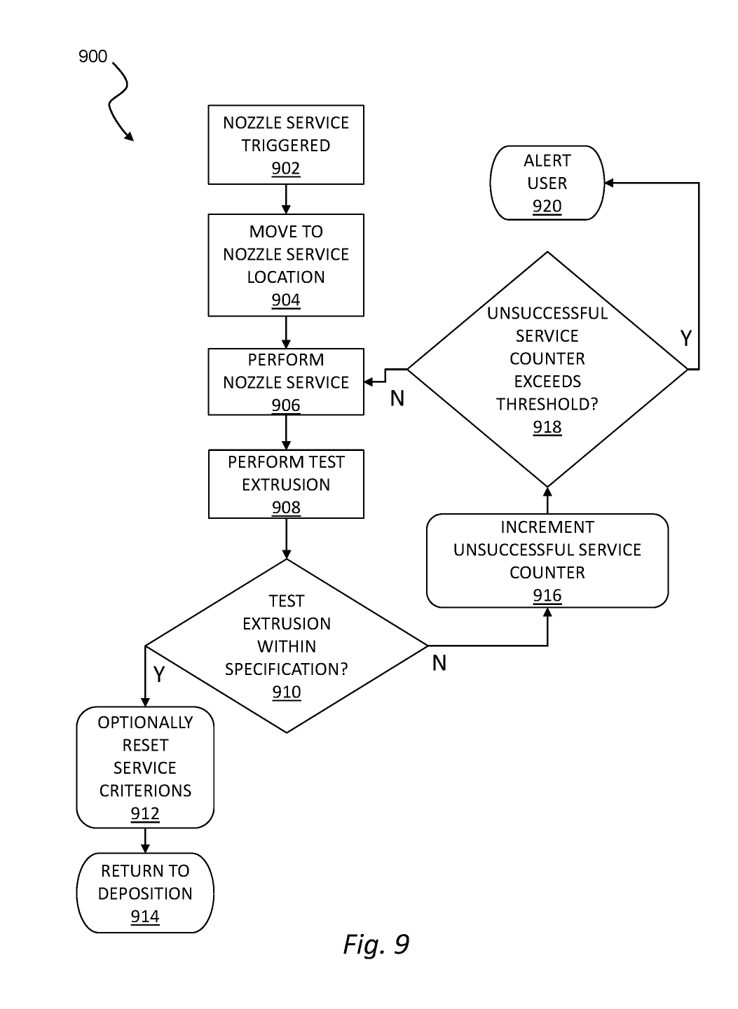

An example of a layer of an object and its path instruction set is presented, along with an example of nozzle service scheduling. An inner perimeter path segment 810 both starts and ends at point 803. An outer perimeter path segment 808 starts and ends at point 802, which is near to point 802. As an example, upon completing the deposition of the 808 outer perimeter path segment, the nozzle service schedule may command a nozzle service, due to the total mass of extrudate deposited since the previous nozzle service, per the scheduled printing method 600 shown in FIG. 6. The nozzle traverses to the nozzle service station 818. As previously mentioned, the nozzle service station 818 may include auxiliary equipment which assists in the nozzle service routine or routines. Nozzle service steps 900 may be performed as shown schematically in flowchart form in FIG. 9. Upon successfully completing the nozzle service steps 900, the nozzle then traverses from nozzle service station 818. The nozzle then may return to build the object 809, for instance by depositing the next path segment 805 at point 804. The nozzle then may move to point 817 to deposit the infill path segment 816, which is a relatively long, somewhat serpentine path, with several changes of direction and parallel portions. Near the end of path segment 816 at the point denoted by the X 814 it may be that, per the reactive printing mode 500 shown in flowchart form in FIG. 5, upon a query 504, the controller determines that the extrusion force exceeds a predefined threshold, which the nozzle service scheduler interprets as a flow obstruction and takes the immediate action of ceasing the extrusion, decelerating the robotics quickly and recording the interrupt position 506. The nozzle then performs 508 nozzle service, for instance following the steps 900 shown in FIG. 9. The nozzle then returns 510 to the object 809 near the interrupt position 814 and resumes depositing 502 the remainder of the path segment 816 which is path segment 812.

As shown schematically in flow chart form in FIG. 5, the controller performs a set of method steps 500 as part of conducting reactive printing. The controller is receiving signals from all of the sensors discussed above, and queries 504, whether a monitored service criterion such as feed force, exceeds its maximum threshold. If not, the controller proceeds to normally deposit II02 material. An error condition may be a clog or a jam in the nozzle, or more generally any high feed force event. However, if the controller determines that an error condition has occurred, the controller ceases printing/extrusion and records 506 the position that this error has occurred. Typically, because error conditions arise at unplanned, unexpected and unpredictable moments in time, the extruder nozzle will often be printing a segment, rather than between segments. Thus, if possible, it will be beneficial to return to the location along the segment where the error and interruption took place. The controller then initiates 1108 an immediate nozzle service, despite the fact that the nozzle may be within a segment. As used herein, error condition means any condition that prompts a nozzle service while printing. Such prompts are also called reactive conditions and give rise to a reactive nozzle service.

The build material feed force limit may be fixed, or it may be based on the instantaneous operating conditions, or it may vary throughout the course of fabricating an object. For example, if the outlet temperature increases, the force limit may be appropriately decreased, to maintain a similar factor of safety.

In some cases, it may be possible to react to the rate of a change in measured force over time (or distance printed, or other parameter over which the force can be measured), as opposed to reacting to a cross of the threshold, as mentioned above. That is to say, an error condition may alternatively or additionally be inferred from a steep slope on a force versus time or distance graph, during an operation for which such a slope would otherwise be unexpected. (Also, if some parameter other than force is measured, such as linearity of the extruded segment, and it can be quantified and thus its rate of change can be quantified and appreciated, then the rate of change of such a parameter may be treated similarly to force, as discussed.)

Due to the unplanned nature of the occurrence of error conditions, a reactive nozzle service action may be required at any point along the build path. Typically, as shown schematically in flowchart form in FIG. 5, which is discussed in more detail above, when an error condition is detected, such as when the controller conducts a query 504 and determines that a service criterion exceeds its threshold, printing of the build material ceases 506, and the nozzle is moved away from the fabricated object to perform 508 a service routine. Then, after the service routine is completed, the nozzle returns 510 to the fabricated object and resumes building the object by printing 502 material. It is difficult to smoothly connect the line of material extruded before and after the error condition. At the junction between these lines, the print interruption may result in a range of defects, such as for instance gaps, variations in cross section, and vertical spikes. The severity of these defects may vary depending on the location in the object, the print parameters and the error condition.

The most common defect is the occurrence of a gap between the two lines. A common source of such a gap is a mismatch between the location in which the error condition occurred and extrusion ceased 505 and the location to which the nozzle returns 510 at which the print is resumed 502 after completion of the service routine. It is therefore desirable that when an error condition is detected, the associated position along the build path is recorded 506, such that following the service routine; the print can be resumed 510 and 502 at or very near to this position.

In some cases, however, the position at which the error condition was detected may not necessarily be the position at which an undesirable nozzle condition, such as a clog, first manifested itself. Due to such a delay between the occurrence of a print problem and the detection of a corresponding error condition, it may be desirable to resume 502 a print at a point on the build path that precedes the detection of the error condition where printing ceased 506, by a certain offset distance. For instance, if a clog in the nozzle prevents extrusion of build material for some time before it is detected, then it may be desirable to resume the print at the position where the flow of extrudate stopped rather than where the error condition was detected 506. The offset distance may depend on a variety of factor such as the extruder geometry, the print parameters and the type of the error condition. While a suitable offset distance may be determined on a case by case basis for instance by optical image analysis based on a camera image of the printed line geometry, it is often sufficient to define a global offset distance through trial and error, that is suitable to correct the majority of the line gaps.

Fabrication of an object is based on a set of machine-ready instructions representing a build path which is executed by the printer. The build path is typically created prior to the print, without any knowledge of the error conditions that may arise during the print. As discussed above, defects resulting from print interruptions due to error conditions, can be minimized by resuming the print at the correct location. Therefore, it is desirable to have the ability to insert new waypoints into the build path, such that the print may resume at the desired location after completion of a service routine. For instance, if an error condition is detected within a path segment it may be desirable to split the path into two by injecting an artificial start point where the error condition was detected. Following the service routine, the nozzle may then resume printing at the aforementioned start point.

While a beneficial embodiment of the present teachings is to restart the print close to the point where an error condition was detected, alternative approaches to complete the deposition of the entire build path may also be feasible. For instance, it may be beneficial to resume the print at another point and only later to complete the path that was interrupted by the error condition. For example, if a nozzle service occurs during an existing path segment, the printer need not complete the remaining portion of the path segment immediately following service. It may, for example, jump to the next path segment in the instruction set and complete the remaining portion of the interrupted path segment at a later time, preferably before moving onto the next layer in the object. As another example, depending on the distance between the service area 818 (FIG. 8) and the location where the error condition occurred, the overall print time may be reduced by resuming the print at a location that is closer to the service area than the error location. This may be achieved by generating a new build path after an error condition occurred. The new build path may consider previously unavailable information, such as the location of the error condition (i.e. where the print was interrupted), the type of error condition, as well as the location of the nozzle after completion of the service routine. Based on this information, a new build path can be generated and optimized to reduce the time required to build the object and to minimize print defects resulting from error induced print interruptions.

While it may be important to resume a print at the correct location following a service routine, other techniques may also be employed to further minimize line gaps and address the other types of defects described above. For instance, upon returning from a service routine and before resuming a print, the temperature of the extrusion nozzle may be temporarily increased beyond the normal operating temperature in order to melt vertical material spikes or other undesirable physical features that might extend from the end of the previously extruded line. This temporary increase in temperature also results in an increase in liquid fraction of the first build material that is extruded upon resuming the print. This higher liquid fraction may help to bond the beginning of the new line to the end of the previous line and smooth out any inconsistencies at the junction between the lines. Another technique to minimize these print defects is to extrude extra material when the print is resumed such that excess material may fill in any gaps or cover any undesirable features that might exist at the junction between the two lines.

While many of the above techniques to reduce print defects were discussed in the context of unplanned error conditions, these techniques may also be usefully employed for planned nozzle service events. While planned service events are less disruptive to the print and typically result in fewer and less severe print defects, the print defects that occur may still benefit from applying the above techniques.

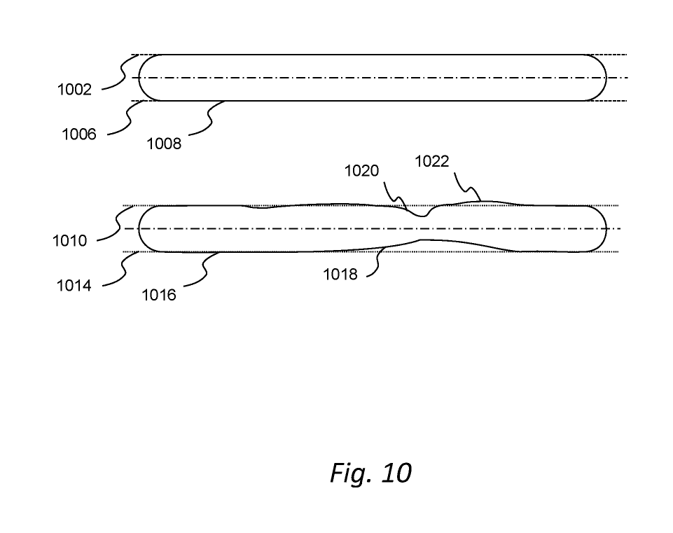

As mentioned above, the shape of the extruded segment may be monitored via an optical sensor, such as a camera 150 (FIG. 1) or 353 (FIG. 3), laser micrometers, range finders, or the like, possibly with the aid of structured light. FIG. 10 illustrates, schematically, in plan view, a well-formed segment 1008 and a poorly formed segment 1016. Deviations 1018, 1020, and 1022 in the shape of the extruded segment 1016 in locations where none are expected may indicate possible obstructions building up in the nozzle or other undesirable conditions, and may be treated as an error condition warranting nozzle service in combination or separate from evaluating the extrusion force. A segment printed in a plane may have zero, one or two detectable edges 1002 and 1006 in its 2D projection, as viewed from above the deposition looking down on it. Specifically, if the segment is printed without any neighboring segments touching it, as is often the case in infill geometries, and as shown in FIG. 10 at 1010 and 1014, it may have both the left and right edges free and detectable. If the segment is printed with a neighbor touching it on one edge, as is often the case in perimeter walls, it will have the free edge detectable. If the segment is printed between two existing segments, then it will have zero free edges. Using techniques known by a person with ordinary skill in the art, one may discern the boundary of the free edge or edges. With this continuous or discrete edge profile, many mathematical metrics may be used to judge the uniformity of the printed segment. For example, quantities such as the arithmetic mean or root mean squared may be calculated for one or two edges and compared to an acceptable quantity. Simpler techniques may evaluate the position of the edge with respect to a permissible deviation. It should be noted that while the path segments in FIG. 10 are straight, the same concept applies to path segments that have curvature (that is to say, path segments may be potentially arbitrary and curvilinear). It should also be noted that while the examples presented here are projected into 2D the concepts here may be extended 3D as well.

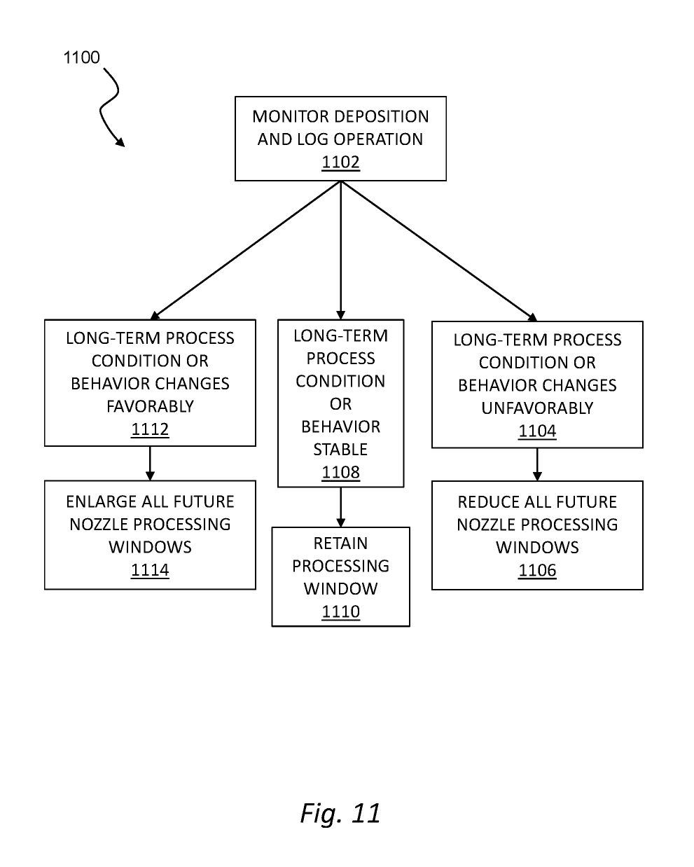

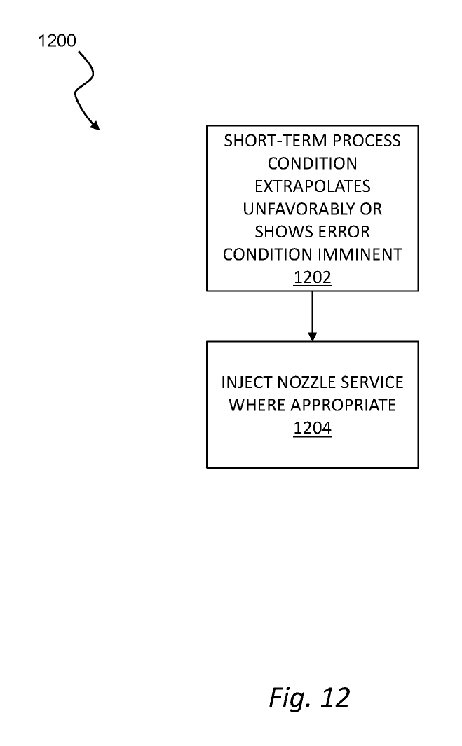

Before, or during the course of print, the printer or the user may select between anticipatory (as shown generally with reference to FIG. 6 (without looking ahead), FIG. 7 (with looking ahead) or solely reactive nozzle services (as shown generally with reference to FIG. 5) or some combination of the two (as shown generally with reference to FIGS. 11 and 12, with variations and modifications shown in other figures). In general, solely reactive operation will result in faster total printing times, but with a higher risk of small defects appearing on or in a fabricated object. Predominantly anticipatory operation will result in increased total printing times, but with a lower risk of object defects. The user may choose the exclusive or predominant mode of service based on the needs at the time.

Furthermore, according to the method 1200 shown schematically in flowchart form in FIG. 12, monitoring quantities of relatively short-term process conditions and possibly extrapolating or forecasting them forward in extruded quantity may be used to insert an unscheduled but still anticipatory nozzle service. For example, observation by measurement of a linearly increasing extrusion force may be extrapolated forward in time or extrusion distance. If the extrapolated force is predicted 1202 to unfavorably exceed a force threshold before the end of the segment, the controller may inject a nozzle service where appropriate, 1204, such as by splitting the segment into two by injecting an artificial end point. The nozzle may be serviced after the aforementioned end point, and then resume the remainder of the path segment. Other appropriate nozzle service schedules 1204 are possible, depending on the situation. For example, if the extrapolated parameter predicts exceeding a threshold shortly after completing the current path segment, then the controller may schedule a nozzle service after the completion of the current path segment. As yet another example of appropriate nozzle service scheduling 1204, if the extrapolated parameter predicts exceeding a threshold after the completion of the upcoming path segment, then the nozzle service scheduler may schedule a nozzle service after the completion of the upcoming path segment. The process conditions contemplated herein are based upon the behavior of the process since, at the earliest, the last nozzle service. Furthermore, information regarding the upcoming path segments may be used in refining the forecast. A similar modality exists where a signature in the monitored process variable or variables is indicative of a forming or imminent error condition.

It should be noted that multiple nozzle servicing techniques may be employed simultaneously. In this case, the nozzle service scheduler may select the most conservative outcome from the various techniques. The nozzle service scheduler may also shift any scheduled service due to a completed nozzle service. For example, if there was a reactive nozzle service performed at 400 g of material extruded and the operating window is set to 500 g, then the operating window may be reset such that the next schedule service occurs after another 500 g is deposited and not after the next 100 g is deposited.

The nozzle service schedule may adapt in response to measured or elapsed process conditions. For example, if error conditions are occurring at a frequency higher than statistically expected (i.e. the printer is not achieving the a priori expected value of distance printed between error conditions, the nozzle operating window may be appropriately shortened.

Material buildup in the nozzle may narrow, constrict, or otherwise impede the flow of build material through the nozzle, leading to higher extrusion forces. Additionally, buildup may cause the temperature of the build material at the outlet to drop slightly, as the buildup may impede the heat transfer from the walls of the nozzle to the build material. Many metallic build materials exhibit decreasing apparent viscosity with increasing temperature. In this way, buildup in the nozzle may further lead to higher extrusion forces. Therefore, it is possible to infer the condition of the nozzle from the force required to extrude build material at predefined conditions. Using this and other similarly diagnostic knowledge, according to a method 1100, as shown generally in FIG. 11, a moving average of the extrusion force may be used to infer the amount of buildup in the nozzle and move forward 1106 or delay 1114 the scheduled nozzle service.

As discussed briefly above, under a method 1100 that is based on both anticipatory and reactive concepts, the controller is continuously monitoring 1102 all sensors, including force, optical, current, etc. and logging the details of the sensor readings and other conditions at the time. It should be noted that the logged information 140 (FIG. 1) may date back to previous nozzle services, the start of the print job, the start of previous print jobs, or the installation of the nozzle, for example. Generally, there are three different paths the controller may follow. If the sensor measurement and logging of data, and analysis of that data indicates 1108 that process conditions, and thus extruding behavior is likely to be stable, then the controller retains the size of the operating window as it has been previously set. If, however, the sensor measurement and logging of data, and analysis of that data indicates 1104 that process conditions, and thus extruding behavior are changing in an unfavorable manner, then the controller reduces 1106 the size of the operating window so that future nozzle services will generally take place sooner than they would have, based on the schedule that was in place. If, however, the sensor measurement and logging of data, and analysis of that data indicates 1112 that process conditions, and thus extruding behavior are changing in a favorable manner, then the controller enlarges 1114 the size of the operating window so that future nozzle services will generally take place later than they would have, based on the schedule that was in place. In this way, the current best estimate of a conservative nozzle operating window may be dynamically and continuously updated based upon process information, to avoid unnecessary nozzle service steps while guarding against true error conditions.

Any metric that can be tracked short-term may also be tracked long term, and, potentially, averaged, moving averaged, exponentially weighted moving averaged, combined in a weighted average with other measures, or otherwise processed by some function known in the art. Examples of short-term process conditions include extrusion force (inferred through any means, for example by measuring the force of the build material on the nozzle or the current on the extruder drive motor), optical observation of the extrudate, and any other measurable process quantity. Both the amplitude information and spectral information of these monitored quantities may be used (for example, by taking a Fourier transform or fast Fourier transform, the spectral density, or other techniques as known in the art). Long-term process conditions include all of the short-term quantities, as well as all possible process metrics such as elapsed extrusion time, extrudate distance deposited, extrudate mass deposited, extrudate volume deposited, number of segments deposited, and number of layers deposited. Additionally, information regarding all nozzle services, and the conditions which triggered them may be used.

The force required for extrusion may be measured at multiple locations. For example, the force exerted by the feeder system 312 onto the build media 310 may be measured such as with a sensor 328, in combination with the force exerted by the build media on the nozzle as with a sensor 329. In steady state and neglecting any frictional effects, these two forces should be equal in magnitude. If this equality becomes significantly violated, an error condition may be inferred. For example, if the feeder force measurement is higher than the nozzle force measurement, there may be an issue with the supply of incoming build material 310 and not an issue with the nozzle at the outlet 316. If the nozzle force reports markedly lower than the feeder force, then it can be inferred that there may be excessive back-pressure near the nozzle outlet 316. Successive spikes where the nozzle force is markedly lower than the feeder force may indicate an imminent error condition, and may trigger a reactive service. The threshold force that would trigger a service may be compared to: the average of the two force measurements; the weighted average of the two force measurements; the maximum of the two force measurements; or the minimum of the two force measurements; or any other combination of the force measurements.

In one embodiment, a printer may employ a plurality of substantially identical nozzles or extruders. While a single nozzle is undergoing service, another nozzle may become active and continue the fabrication of the object. In this way, the time required for servicing a nozzle does not add appreciably to the total print time. If the entire extruder is duplicated, the clean extruder takes over. If the nozzle is duplicated, the clogged nozzle is moved away from the primary build material feed device 312, and the clean nozzle is installed in place of the clogged nozzle. These motions may be accomplished by mechanisms, such as a tool changer, auxiliary collinear axes or other methods known in the art. They may be taken in the nozzle service area 818, or elsewhere.

In another embodiment, in a printer that employs two or more extruders, it may be possible to schedule nozzle service during a time where it would otherwise be idle. The extruders may serve different purposes and may not run concurrently. For example, on a printer that employs one extruder for depositing the primary metallic build material and a second extruder for depositing a support material, the primary extruder may be serviced while the second extruder is depositing material. The controller 118 may advance or delay a scheduled nozzle service to align the service in time with a second nozzle deposition event, based upon the print's digital instruction set. In this way, the time required for servicing the nozzle does not add to the total print time.

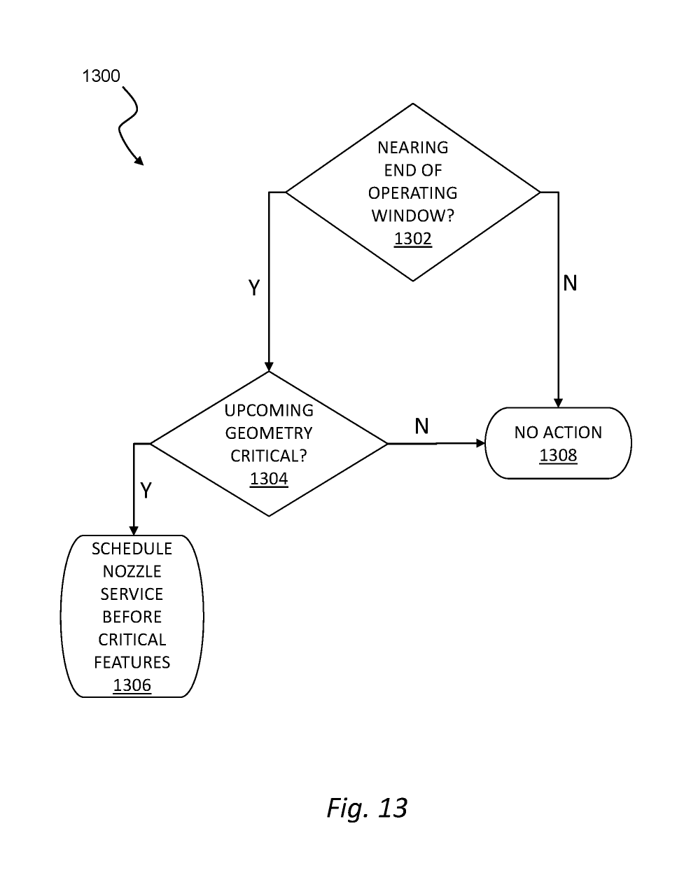

Some features of parts are critical, and other parts are less critical, or not critical at all. Examples of critical object features may include surface features, such as outermost perimeter walls or upper or lower surfaces, or bridging. Examples of less critical object features may include infill or inside perimeter walls. Any interruptions in a path segment in a critical feature or region may be deemed unacceptable, depending on the final demands for the fabricated object. Extruding critical feature may benefit from special considerations, illustrated schematically with reference to method 1300 in FIG. 13. Because the likelihood of occurrence of an unexpected nozzle error condition increases over time, and thus, toward the end of an operating window, it is beneficial for the controller to query 1302 whether the end of an operating window is near. If not, then no special action (regarding nozzle service) is taken 1308. If so, then the controller query's 1304 whether a critical object feature is upcoming. If yes, it is prudent to anticipatorily schedule 1306 nozzle service before extruding the critical object feature.

Similar to the long-term monitoring and tracking presented in FIG. 11, the controller 118 may monitor deposition and log all the relevant information and create a log file for a particular nozzle since its installation or any other important nozzle life-event. It is then possible to create a metric for nozzle health, which metric changes as the nozzle is used and its likely health condition deteriorates. By way of non-limiting examples, some quantities that may be tracked are: the total amount (by volume, mass or distance) of build material extruded; a moving window time average of the extrusion force; the time and details and totals of the nozzle services performed and the cause for each; the amount of build material processed; the number of path segment starts; the time at operating temperature between each nozzle service; the type of build material and operating temperatures; and the number of thermal cycles. Using the logged quantities and a weighting function, a number representing a nozzle health metric may be computed. The nozzle health metric and the modification to the nozzle operating window may be functionally similar.

If the nozzle health metric drops below a predefined quantity, then the printer controller may signal the need for a nozzle replacement to occur. That is to say, it has been inferred that continued operation will be ineffectual, or otherwise problematic, due to deterioration of the performance of the nozzle. A particularly desirable embodiment of the nozzle health metric employs a weighted average of the total amount of build material extruded and the number of nozzle services performed. For example, nozzle_health %=100−A*extruded_distance−B*number_of_nozzle_services, where A and B are constants which are experimentally determined for the process in question over a sample of nozzles.

It should be noted that logging of process variables may contain both spatial, temporal and amplitude information, as well as potentially corrections or normalizations for the current state of the process. For example, it is known that the extrusion force at the same build material feed rate increases with decreasing nozzle temperature. As another example, extrusion force increases with increasing build material feed rate at the same temperature.

As described above, flow artifacts within a nozzle of an extrusion-based additive manufacturing system can lead to accumulations of solidified material that clog a nozzle of the extruder or otherwise interfere with movement of material through the nozzle, particularly where the extrudate includes multi-phase metallic materials or the like. Furthermore, such accumulations may upset the heat transfer to the build material. The following nozzle service methods may be employed to mitigate such flow artifacts and any would-be resulting flow interruptions.

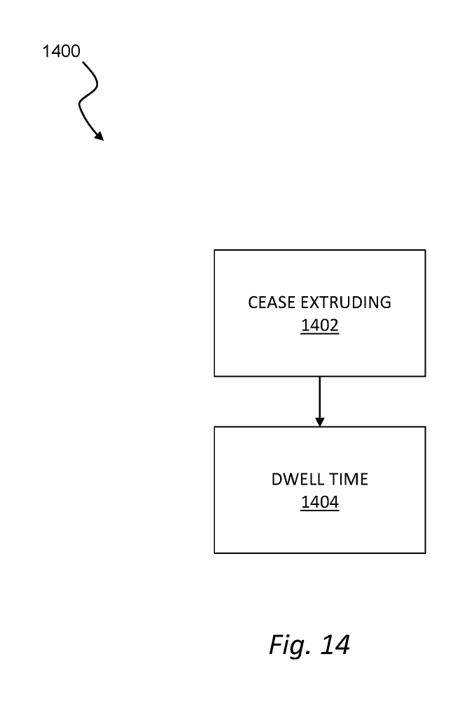

In one method embodiment 1400, shown schematically in flow chart form in FIG. 14, conducting the steps of: ceasing the extrusion 1402 and imposing idle time or dwell time 1404 and the associated robotic motions for a short period of time, may result in partial remediation of the nozzle error condition and may enable completion of a particular path segment. The idle or dwell time during the stoppage may be preferably 10 ms, 100 ms, 1 s or 10 s and may vary depending on the particular process and deceleration capabilities of the robotics. Such a stoppage nozzle servicing step may be beneficial for clogs that may manifest due to insufficient heat transfer to the build material or to the momentary dislodging of foreign materials within the nozzle.

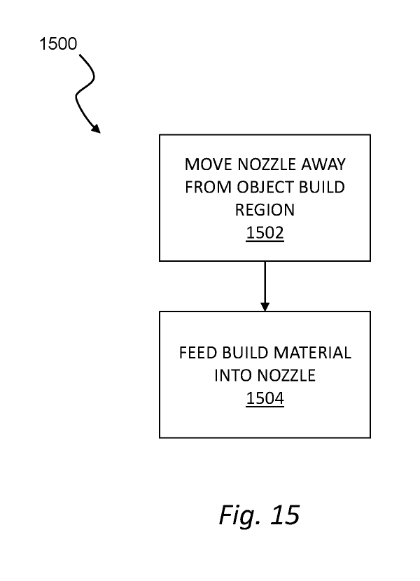

Another nozzle servicing procedure shown schematically at 1500 in flow chart form in FIG. 15 involves moving the nozzle away 1502 from the printed object and the object build region, and then feeding 1504 build material 310 into the nozzle inlet 305. When the nozzle outlet is contacting an object being created, a back-pressure arises. The back-pressure may confine and impede motion of the build material 310 out from the nozzle outlet 316. Moving the nozzle away from the top surface 372 of the forming object so that it no longer contacts the object, may relieve the back pressure. Removal of the back-pressure may be beneficial. The small dwell time required to move the nozzle away from the object and/or disconnecting the nozzle land area from the printed object may allow the temperature of the build material within the nozzle to increase slightly or internally equilibrate with most or all of the other build material in the nozzle, and with the nozzle itself, which may be beneficial. During this nozzle service there is no requirement to synchronize the build material feed rate to the robotic motion of the nozzle, as discussed in detail in the above referenced U.S. patent application Ser. No. 16/038,057, because no object is being printed during a dwell-time event. Therefore, the choice of build material feed rate or feed rates is much less constrained. For example, the build material may be advanced at a rate higher than is possible during normal printing moves due to process or robotic limitations. Furthermore, time-varying build material feed rates may be employed. This is described further in the section below.

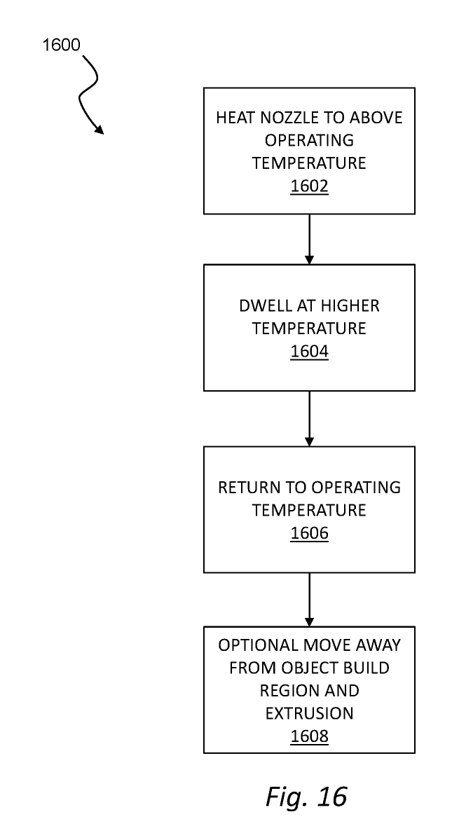

Another nozzle servicing procedure, shown at 1600 schematically in flow chart form in FIG. 16 may rely on heating 1602 the extrusion nozzle 302 to a servicing temperature above the operating temperature at which the build material is typically extruded. Different types of multi-phase build materials may benefit to different degrees from such a temperature increase. Elevated temperature can be particularly beneficial for multi-phase metal alloys for which the solid/liquid fraction is a strong function of temperature. For such materials, increasing the temperature increases the liquid fraction present in the multi-phase material, until the liquidus temperature is reached, at which point the material turns fully liquid. Following a step of maintaining a dwell time 1604 at such an elevated servicing temperature, the nozzle temperature can then be reduced 1606 back to the operating temperature, and printing may resume. This servicing procedure may also be combined with an extrusion step 1608, to purge out or replace the material contained in the nozzle with fresh build material. Typically, the purging extrusion step would be conducted after moving the nozzle away from the object build area, to the service area GG18, so that the object is not fouled by the purged material.

A suitable nozzle servicing temperature may be any temperature above the operating temperature, however a servicing temperature at or slightly above the temperature where the multi-phase metal alloy turns fully liquid may be especially beneficial. In many cases the multi-phase material inside the nozzle turns fully molten at the liquidus temperature of the build material, represented in FIG. 4 by the curves 415a, and 415b, which span a range of compositions. However, in some cases the composition of the material inside the nozzle may locally or globally deviate from the composition of the build material 310 as supplied, and thus may require a higher or a lower temperature to turn completely liquid. Such compositional changes inside the nozzle may result for instance from preferential extrusion of either liquid or solid phases of the multi-phase material, which then over time changes the composition inside the nozzle. In some cases, a servicing temperature at which the solid fraction is low but not zero, may also be suitable to service the nozzle.

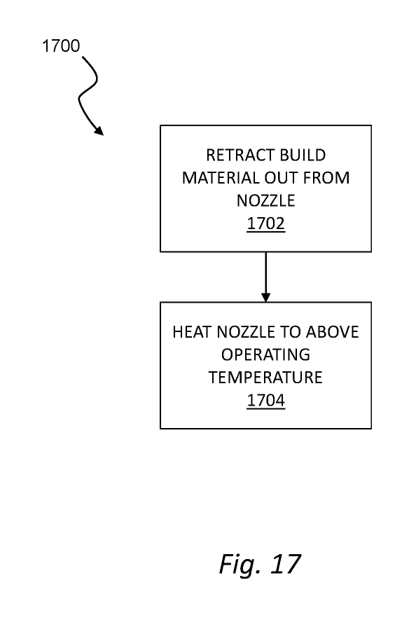

Several general concepts that make up a method 1700 are shown in flow chart form in FIG. 17. Heating 1704 the nozzle to above the operating temperature may have several benefits. For instance, solid particles inside the nozzle that presented a flow interruption at the operating temperature may melt and thus dissolve as the nozzle is heated. This may be particularly beneficial for large particle build-ups or for individual large particles, which may have coarsened or ripened to a size much larger than the average particle size, due to a long dwell time inside the nozzle. These particles may be present in localized build-ups that can result in flow restriction. As the multi-phase material inside the nozzle turns fully molten, its composition homogenizes such that after the nozzle temperature is reduced back to the operating temperature, the solid particles are distributed homogeneously throughout the nozzle. Another benefit of heating the nozzle, is that the higher liquid fraction at elevated temperature results in a reduction of the viscosity of the multi-phase material. This viscosity reduction may help dislodge and purge out flow restriction resulting from build-up solid particles as well as foreign species and oxides. Therefore it is often beneficial to combine nozzle heating with feeding new build material into the nozzle to force the preceding build material out of the nozzle at elevated temperature.

It may also be beneficial to retract 1702 the build material filament back out from the nozzle inlet before the nozzle temperature is increased to the servicing temperature. This is because, due to the high thermal conductivity of many MCMP build materials, if the build material remains in thermal contact and proximity to the nozzle inlet, a significant amount of heat may be lost from the nozzle through the build material filament. This heat loss mechanism may introduce temperature gradients in the interior of the nozzle during the servicing step, which might negatively affect the effectiveness of the servicing procedure. For instance, heat loss through the incoming build material may lower the temperature of the multi-phase material inside the nozzle below the desired servicing temperature. This local reduction in temperature may result in a locally higher solid fraction, which may negatively affect the servicing procedure. For example if a servicing temperature is set to at or slightly above the liquidus temperature, with the intention to completely melt the multi-phase material inside the nozzle, near to and around the incoming build material filament, the temperature may still be below the liquidus temperature and solid particles may still be present. Retracting the build material filament from the nozzle breaks the thermal conduction path, and eliminates such temperature gradients inside the multi-phase material.

After the material that is within the nozzle has turned sufficiently molten, it is beneficial to remove this material from the nozzle, as new microstructures—for example dendrites—may form during the solidification process which may pose future extrusion problems.

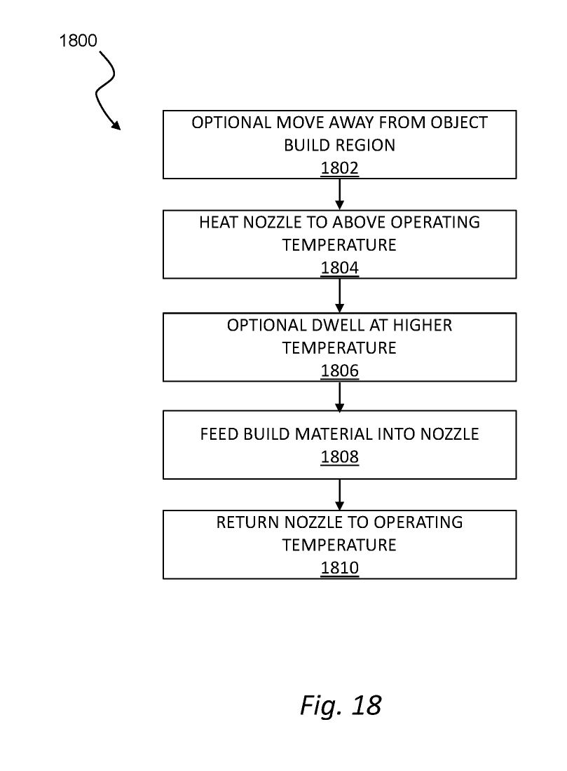

A technique 1800 is shown schematically in flow chart form in FIG. 18, for clearing a nozzle bore of fully or mostly molten material. An optional first step is to move 1802 the nozzle away from the object build region. The nozzle is heated 1802 to above the operating temperature, at which temperature it may optionally be maintained 1806 for a dwell period. New build material 310 is fed 1808 into the nozzle inlet 305. This may be performed before, or concurrently with cooling 1810 the nozzle and returning it back to the nominal operating temperature for the alloy and process in question. Feeding 1808 new build material may be performed at a constant build material feed rate, or with time-varying build material feed rates. For example, the build material may be fed forwards and then backwards, with the sum of the forward and backwards motions resulting in net material added to the nozzle, in a manner discussed in some detail in the above referenced U.S. patent application Ser. No. 16/038,057. It is useful to note that the variable and different build material feed rates as discussed in the 16/038,057 application are used for entirely different reasons than would be these variable build material feed rates discussed here, and they occur at different phases of an object building session. For the 165/038,057 techniques, build material is being extruded into an object during times of varying build material feed rates. For the matters discussed and disclosed herein, build material is not being extruded into an object being formed, but rather the object is not being formed at the moment, and build material is being ejected from the nozzle outlet during a nozzle servicing event. Applying a time-varying feed rate profile may increase agitation of the molten material within the nozzle, which may further dislodge any foreign species that may be present in the nozzle. It should be noted that since the nozzle is no longer contributing material to the printed object during these servicing steps, it is possible to perform extrusion with parameters that would not be possible during normal extrudate depositions due to process or machine limitations. For example, extrusion feed rates above those which the robotics can support or extrusion temperature above which function for the process may be employed to facilitate, encourage, or otherwise assist in the removal or dislodging of full or partial obstruction or occlusion of the nozzle outlet or other buildup within the nozzle bore.

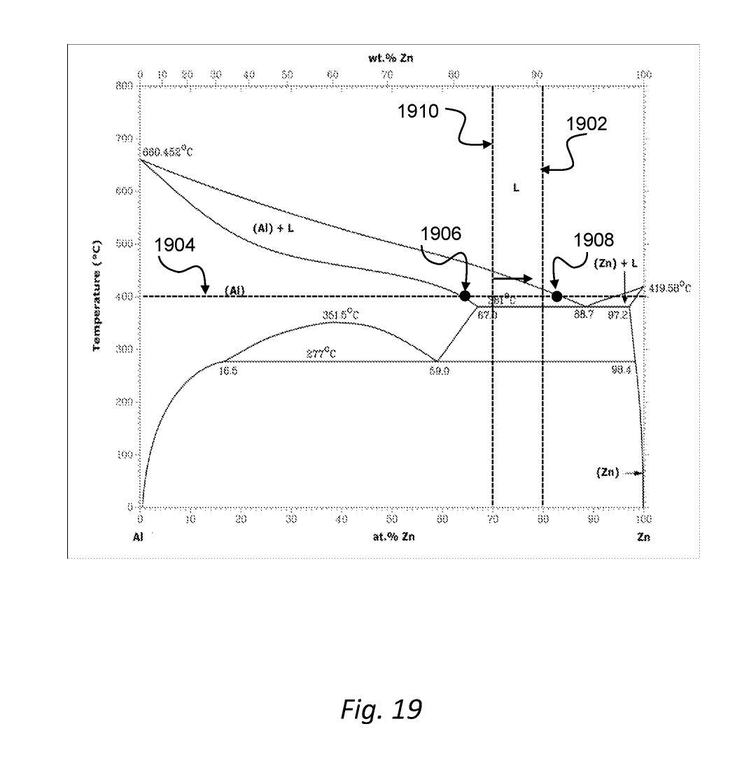

An example of such a servicing procedure may include the following steps. For a build material that is a zinc aluminum alloy, such as for instance an alloy with the composition 1902 shown in FIG. 19, the nozzle is heated 1804 from an operating temperature of 400° C. (at which temperature the build material is in a multiphase state) to a servicing temperature of 450° C., (at which temperature it is in a substantially fully liquid state). After an optional dwell time 1806 of 30 seconds, the nozzle is cooled 1810 to return the nozzle temperature back to the operating temperature. New build material is fed 1808 into the nozzle. The feed rate may use a variable feed rate profile consisting of forward and backwards segments, with extrusion lengths of 8 mm and 6 mm, respectively. The steps of feeding 1808 the build material and returning 1810 the nozzle to the operating temperature may be conducted simultaneously, or the feeding step may be begun first.

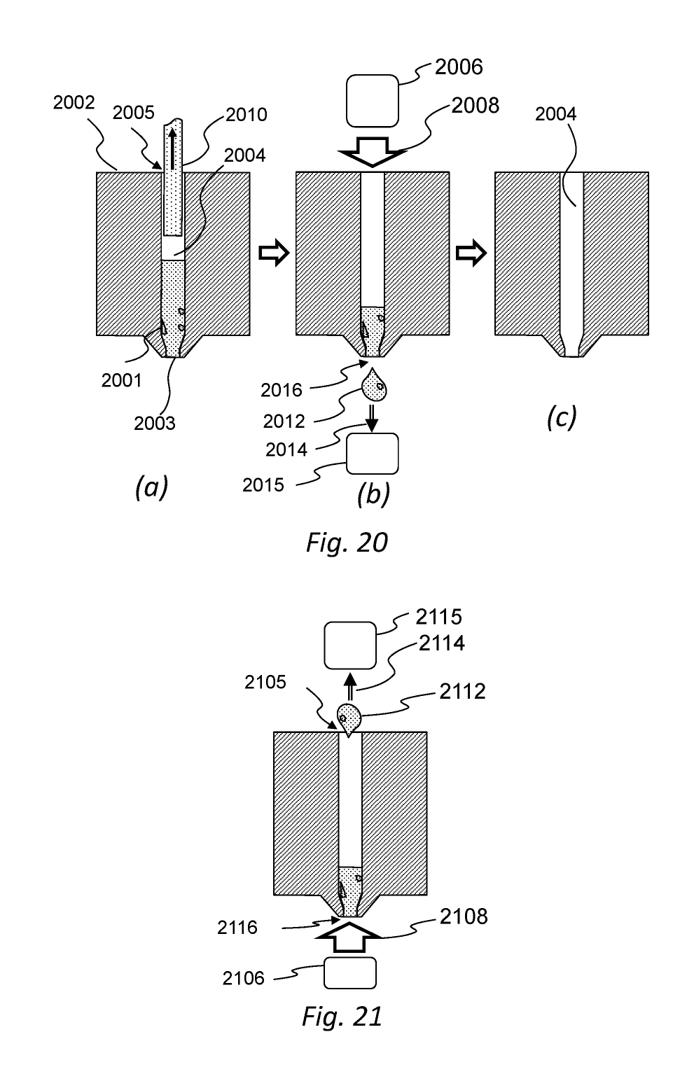

Another technique, as shown schematically with reference to FIG. 20, shown in three stages, (a), (b) and (c), for clearing a nozzle bore 2004 of fully or nearly fully molten material 2003, perhaps with foreign phase flow obstructions, or the like, 2001 included, can apply a pressure differential or gas flow. The gas may be inert or sufficiently inert so as not to chemically interact with the molten or partially molten material inside the nozzle 2002. For example, argon, nitrogen or carbon dioxide may be sufficiently inert. The build material feed stock 2010 is removed from the nozzle inlet 2005. The gas 2008 may be administered near the nozzle inlet 2005 by an auxiliary nozzle 2006 or the like and liquid or liquid containing material 2012 is expelled from the nozzle outlet 2016. This gas nozzle may optionally seal to the extrusion nozzle inlet 305 or around the build material 2010. The gas flow rate may be quickly turned on and off one or multiple times through the use of a valve or the like. The high flow rates and pressures of the gas jet may direct most of contents of the extrusion nozzle to exit the nozzle through the outlet 2016. It may be beneficial to retract the build material filament 2010 from the nozzle before the gas flow or pressure differential are administered.

In another embodiment, also shown schematically in FIG. 20 an area of low pressure, for instance generated by a differential between a pressure source 2006 at the nozzle inlet 2005, and another, lower, pressure source 2015, at the outlet 2016, is presented at the nozzle outlet 2016 and the subsequent inrush of gas 2008 into the nozzle inlet 2005 and towards 2014 the low pressure source 2015, performs the same function of expelling material out of the outlet 2016. The pressure source 2012 at the nozzle outlet may be, for instance, a vacuum source, and the pressure source 2006 at the nozzle inlet may be a positive source.

In yet another embodiment, FIG. 21 shows a variation of the nozzle clearing techniques described above and shown in FIG. 20. In this variation, material 2112 is expelled from the nozzle inlet 2105 rather than from the nozzle outlet 2116. And instead of administering a gas 2108 near the nozzle inlet 2105, the gas 2108 may be administered near the nozzle outlet 2116 by an auxiliary nozzle or the like 2106, such that liquid or liquid containing material 2112 is expelled from the nozzle inlet 2105. Analogous to FIG. 20, a low pressure source 2115 may be used in addition to the high pressure source 2106 in order to generate a pressure differential between the nozzle outlet 2116 and the nozzle inlet 2105. The resulting inrush of gas 2108 into the nozzle outlet 2116 and towards 2114 the low pressure source 2115 also expels the material 2112 out of the nozzle inlet 2105. The pressure source 2115 at the nozzle inlet may be, for instance, a vacuum source, and the pressure source 2106 at the nozzle outlet may be a positive source.

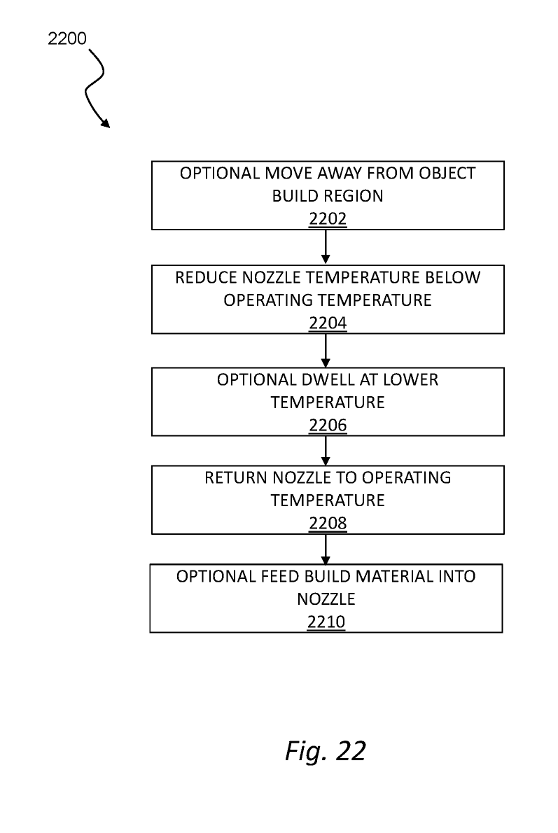

Yet another nozzle servicing technique is shown schematically at 2200 in flow chart form in FIG. 22. Before commencing the actual nozzle servicing step, the nozzle may optionally be moved away from the object build area 2202, to the service area 818, so that the object is not fouled or damaged by the servicing routine. The nozzle servicing technique relies on reducing the nozzle temperature 2204 to a servicing temperature that is significantly below its operating temperature and often below the lower end of the working temperature range of the multi-phase build material. After a dwell time at such a lower servicing temperature 2206, the nozzle is then heated back up to return it to the operating temperature 2208 and printing of the object may resume. This servicing procedure may also be combined with a build material feed and an extrusion step 2210, to purge out or replace the material contained in the nozzle with fresh build material. This optional purging step is typically performed in conjunction with optional step 2202, i.e. away from the object build area, in the service area 818, so that the object is not fouled by the purged material.

The somewhat counterintuitive approach described in connection with FIG. 22 may be particularly beneficial in situations in which the build material undergoes a significant increase in density upon solidification. Preferably the temperature is brought well below the solidus temperature (in those systems which have a solidus). However any substantial decrease in temperature away from the operating point will have some benefit. Solidification or at least partial solidification is most beneficial. As the temperature decreases in the working temperature range, the solid fraction increases, which introduces a beneficial effect. But the effect is typically most beneficial if temperature is reduced to below the solidus temperature to fully solid. The volume reduction following partial or full solidification of the build material and the possible release of any dissolved gases may be sufficient to mechanically dislodge, free up or otherwise disturb any features that may have previously clogged, jammed or otherwise limited the flow of extrudate from the nozzle.

A similar mechanical dislodging effect may be present in cases in which the thermal expansion coefficient of the build material differs significantly from that of the material inside the nozzle (i.e. build material and any present undesirable species such as oxides, carbides, high melting intermetallics etc.). Reducing the temperature well below the solidus temperature thus would result in different shrinkage rates of the nozzle and the material contained in it and the resulting mechanical action may free up any features that may have previously clogged, jammed or otherwise limited the flow of extrudate from the nozzle.

Yet another scenario in which a reduction in nozzle temperature may be beneficial to clear flow artifacts from the extrusion nozzle, is one in which solidification of the build material is associated with significant changes in phase compositions and fractions. This case is particularly applicable to multi-phase metal alloy build materials, such as a composition in an alloy system with a eutectic/peritectic/isomorphous, or other systems, exhibit at least one solid phase and one liquid phase. Upon solidification and further cooling of such materials it is possible that the regions of the material that corresponded to solid particles in the multi-phase state undergo significant compositional changes and spatial reconfiguration as the temperature decreases. For instance the regions that corresponded to a solid particle in the multi-phase state may decompose into regions of multiple phases, each occupying only a fraction of the volume region. Such spatial reconfigurations may have the effect that after heating the nozzle back to its operating point, the configuration of solid particles inside the nozzle may be very different from the one present before reducing the nozzle temperature. For instance, the solid particles may be smaller or be located at different locations within the nozzle. If the flow interruption in the nozzle was caused by the build up of solid particles at certain locations inside the nozzle, such a temperature induced reconfiguration of the solid particles may be able to clear the flow interruption.

Suitable servicing temperatures depend on which of the above mechanism is to be utilized. For instance, to use density changes upon solidification, the servicing temperature should be at or somewhat below the solidus temperature of the build material. At temperatures below the solidus temperature, the material is fully solidified and effects resulting from density changes upon solidification would be maximized. In some cases it may also be sufficient to use a servicing temperature above the solidus at which the solid fraction of the material is higher than at the operating temperature, but not fully solid. To maximize effects resulting from a mismatch in the coefficient of thermal expansion between the nozzle and build material, a much lower servicing temperature would be desirable. The lower the servicing temperature, the larger the mismatch between the nozzle and the material inside the nozzle. Although a servicing temperature as low as possible may be desirable to maximize these effects, in practical terms the time required to achieve such large temperature changes may be the limiting factor, as it is desirable to minimize the time spent in service or servicing procedures and maximize the print time. To take advantage of compositional changes and the resulting spatial reconfiguration of the material, the servicing temperature needs to be low enough to produce sufficiently large compositional changes but at the same time be high enough to allow diffusion to occur at a sufficiently high rate to realize the desired compositional changes within a time frame suitable for nozzle servicing.

The effectiveness of using a reduction in nozzle temperature as a servicing mechanism depends critically on the properties of the nozzle and build materials. The density reduction upon solidification, also known as solidification shrinkage, can vary between 2% to 7% for common casting metals. In particular multi-phase metal alloys, such as some zinc casting alloys and aluminum casting alloys, exhibit values closer to the upper end of this range, making them particularly suitable to benefit from solidification shrinkage during the servicing procedure described above.

Moreover, many multi-phase metal alloys exhibit a coefficient of thermal expansion significantly larger than the coefficient of thermal expansion of many refractory materials that are a suitable for the extrusion nozzle. For instance the coefficient of thermal expansion of zinc (30-35 μstrain/° C.) and aluminum (21-24 μstrain/° C.) is several times larger than that of alumina (8 μstrain/° C.) and graphite (4-8 μstrain/° C.), making them a good combination to achieve a large mismatch upon temperature reduction.

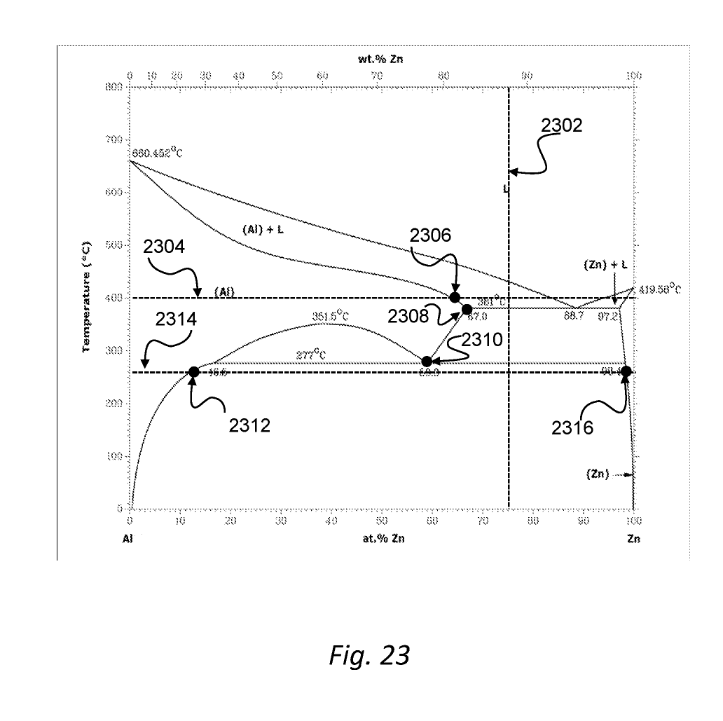

The effectiveness of utilizing changes in phase composition and volume fraction to clear flow obstructions from the nozzle depends very sensitively on the build material. The equilibrium phase diagrams of the build material provides a useful guide to determine if a material is suitable for this servicing procedure and if so, what servicing temperatures should be used. FIG. 23 provides an example of such an equilibrium phase diagram and is used below to illustrate the general guidelines provided here. A good indication that this mode of servicing is promising is if the composition and volume fractions of the stable phases at the solidus temperature change rapidly as the temperature decreases below the solidus. This can be seen in FIG. 23 where the phase composition and volume fraction differs markedly between 381° C. and 260° C. Such compositional changes may require the spatial redistribution of atomic species through diffusion. If redistribution occurs over sufficiently long distances, then reheating the nozzle to the operating temperature may result in a microstructure that is sufficiently different from the one present before cooling down the nozzle. In particular, the number, size and position of solid particles may change significantly, which may help to remove flow restrictions in the nozzle.

As a non-limiting example, this can be illustrated from the equilibrium phase diagram for the eutectic alloy system of zinc and aluminum (see FIG. 23). For a zinc aluminum alloy with a composition of 75 at. % zinc and 25 at. % aluminum 2302, the solid fraction is ˜45% at an operating temperature 2304 of 400° C., according to the equilibrium phase diagram (FIG. 23). In this case, the solid is made up of the (Al) phase, a solid solution of Zn in Al. As the temperature decreases below the operating temperature 2304 the composition of the (Al) phase changes rapidly from 65 at. % zinc at 400° C. (2306) to 67 at. % zinc at 381° C. (2308) to 59 at. % zinc at 277° C. (2310) and to ˜12 at. % Zn (2312) at the servicing temperature 2314 of 260° C. This large change in the composition of the (Al) phase is also associated with a large change in the volume fraction of the (Al) phase, which drops from ˜45% at 400° C. (2304) to ˜27% at 260° C. (2314). Based on these rapid changes in composition and volume fractions, reducing the nozzle temperature to ˜260° C. (2314) during nozzle service may provide efficient removal of flow obstructions in the nozzle.

An example of this servicing procedure may include the following steps. For a zinc aluminum die casting alloy, the nozzle temperature is reduced form the operating temperature of 415° C. to a temperature of 270° C. After a two minute dwell time at 270° C., the nozzle temperature is then increased back to the operating temperature of 415° C. and the material in the nozzle is purged from the nozzle by feeding new build material into the nozzle.

The above described nozzle servicing techniques may be used individually or in combination during a nozzle service. During a nozzle service routine, these nozzle servicing techniques may also be combined with other servicing or service techniques that help maintain or improve the nozzle performance.

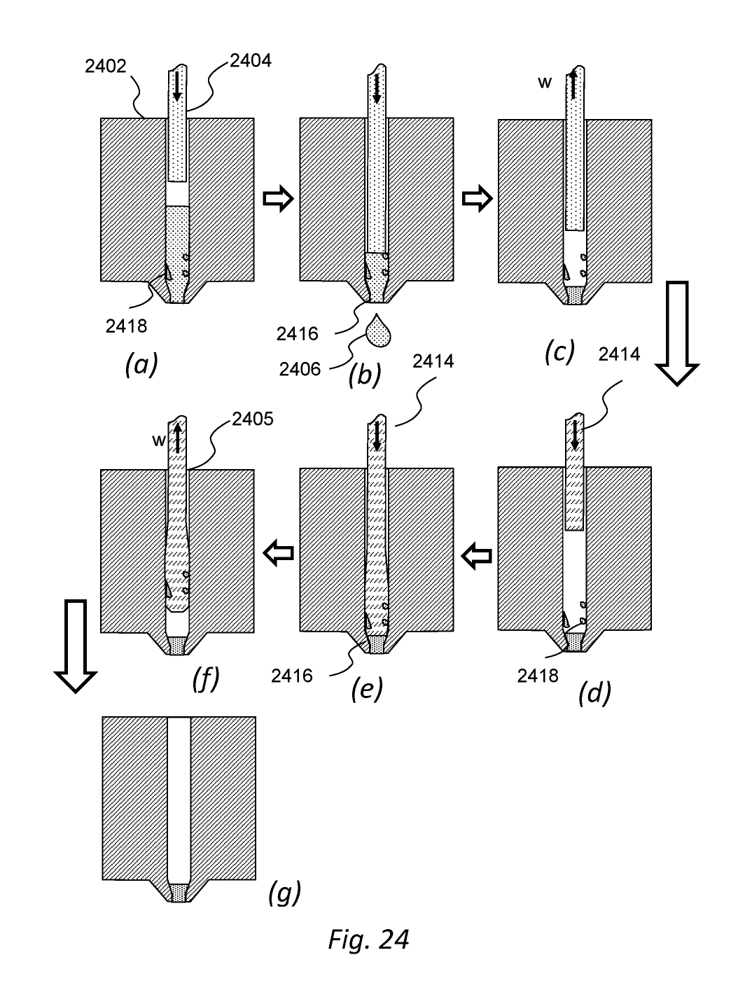

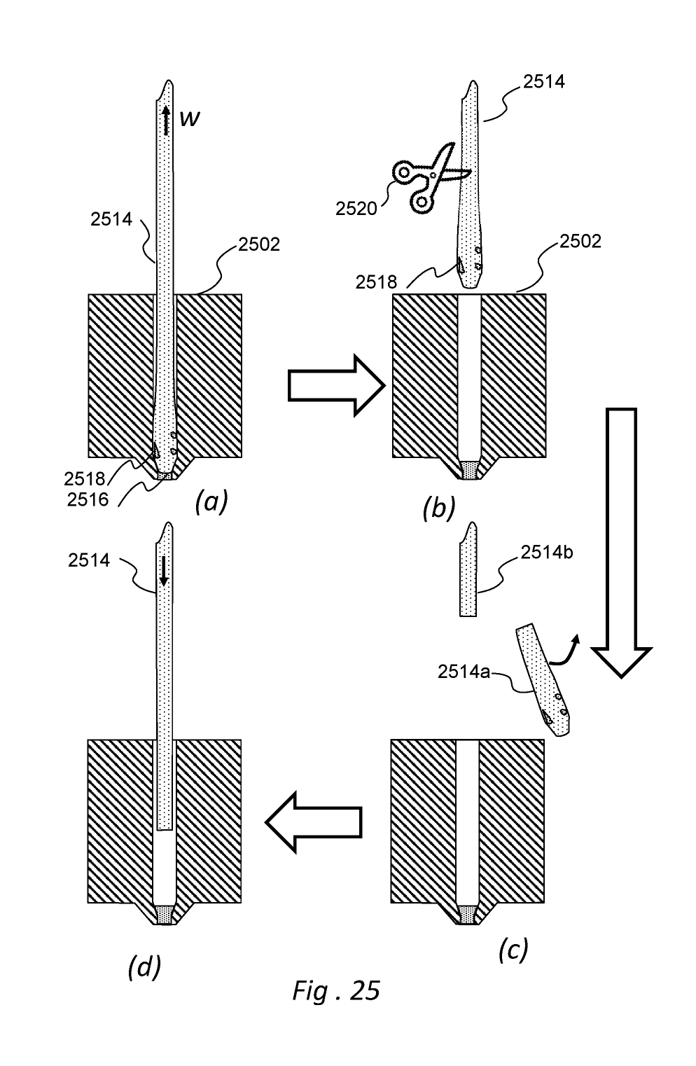

Another technique shown schematically in FIG. 24, in seven stages (a)-(g), to service the extrusion nozzle 2402 uses a two-step process, using a plunger (sometimes referred to herein as a wire). Before a plunger can be introduced into the nozzle, the build material 310 filament is retracted from the nozzle inlet 2405 to make room and give access to the plunger. The plunger is preferably introduced into the nozzle via the nozzle inlet 2405 and then advanced towards the nozzle outlet 2416. In a first, the nozzle temperature is raised to a first servicing temperature, which is within or above the working temperature range of the build material. A first plunger 2404 is inserted into the nozzle inlet 2405 and pushed into the nozzle bore sufficiently far to expel any remaining readily extrudable material 2406 from the nozzle, out through the nozzle outlet 2416. The plunger 2404 is withdrawn, as indicated by the arrow w. In a second step, the nozzle temperature is brought to a second servicing temperature, at which a second plunger 2414 is used to remove the built up solid material 2418 from the nozzle, by withdrawing it out the nozzle inlet, as indicated by the arrow w, with the solid material 2418 retained in some manner by the plunger 2414. These two steps may be achieved by using the same plunger 2404 for both steps or by using separate plungers 2404 and 2414 for each step. Similarly, the first and the second servicing temperatures may be different or may be the same.

The first step of expelling the remaining readily extrudable material can be achieved by using a plunger 2404, preferably in wire, rod or filament form with a diameter similar to the diameter of the feedstock material 310. While the nozzle is at normal operating temperature or somewhat elevated operating temperature, the plunger is preferably inserted into the nozzle inlet 2405 such that any readily extrudable material inside the nozzle is expelled through the nozzle outlet 2416 as the plunger is pushed deeper inside the nozzle and progresses from the nozzle inlet 2405 towards the nozzle outlet 2416. To function well, the plunger is beneficially made from a material with a melting point sufficiently high to keep the plunger in a substantially solid state at the temperatures present in the extrusion nozzle. Moreover, the plunger should preferably not undergo detrimental interactions with the multi-phase build material inside the nozzle. Such detrimental interaction could include the formation of high melting point intermetallics or other mixing or reaction products with a melting point above the working temperature range of the build material. Other detrimental interactions could include contamination of the build material through formation of mixing or reaction products that negatively impact the material properties of the build material and could end up in the printed object following a nozzle service procedure. Such detrimental interactions between the plunger and the build material inside the nozzle can be avoided, for instance by making the plunger from a high temperature inert material. Such inert materials may include graphite, ceramic materials such as alumina, silica and silicon nitride and high melting point metals such as tungsten and tantalum. In another approach the plunger may be made from a material that is compatible with the build material, such that any reaction or mixing products that form inside the nozzle won't detrimentally impact the build material or the ability to extrude the build material from the nozzle. Such compatible materials could include higher melting point metal alloys from the same alloy family as the build material. Such materials may include zinc, aluminum, magnesium, silicon, copper as well as their alloys such as zinc aluminum die casting alloys, aluminum casting alloys and wrought aluminum alloys.

The second step of removing built-up solid material from the nozzle can be achieved by using a plunger that is introduced into the nozzle to bond with, attach to, trap or otherwise hold on to the built-up solid material inside the nozzle, which material is then removed from the nozzle when the plunger is retracted, as shown. As described above, depending on the material choice for the plunger, the interaction between the wire and debris may include mechanical processes such as surrounding and trapping the debris inside the plunger material and the formation of physical and chemical bonds between the debris and plunger materials. The plunger may be made from a rod, wire or filament of suitable material.

To facilitate the attachment of built-up solid material to the plunger, it is beneficial to press the plunger into, spin the plunger around or otherwise move the plunger inside the nozzle to maximize the contact between the plunger surface and any built up solid inside the nozzle.

It is particularly beneficial to use such a plunger for servicing reducing bore nozzles (i.e. nozzles with an outlet cross section smaller than an inlet cross section). By choosing a plunger with a cross section smaller than the nozzle inlet cross section but larger than the nozzle outlet cross section, the wire can be pressed against the nozzle outlet 2416, as shown in the fifth view (e) of FIG. 24, with sufficiently high force to deform the wire until it closely conforms to the internal geometry of the nozzle bore and is in close contact with built up solid residue 2418. This close contact facilitates efficient extraction of the solid material when the plunger is subsequently retracted from the nozzle (back out from the inlet 2405).

Repeated cycles of introducing and removing the plunger into and out from the nozzle may be required to achieve a desired level of cleanliness. To do this, it is desirable to replace the plunger after each introduction/retraction cycle, to discard any extracted material and maximize the servicing efficiency. One particularly beneficial embodiment of this method may be to use continuous wire as the plunger, such that after each servicing cycle the front most section of the wire can be clipped off or otherwise discarded and the following clean section of the wire can be used for the next servicing cycle.

As shown schematically in FIG. 25 in four stages (a)-(d), a continuous wire 2514 can be used as a plunger for the servicing method described above. The first stage (a) in FIG. 25 shows the plunger 2514 pressed against the outlet 2516 of the nozzle 2502, with the particles 2518 to be removed adhered thereto as mentioned above. The plunger and adhered particles is withdrawn (as indicated by the arrow w), and shears 2520 or other suitable equipment is used to sever the end 2514a of the wire 2514 from the continuous portion 2514b of the wire 2514. A new extent of wire 2514 is inserted into the nozzle inlet and the additional nozzle servicing can continue.

The plunger material and the temperature of the nozzle during the servicing procedure can be chosen to realize the desirable features identified below.

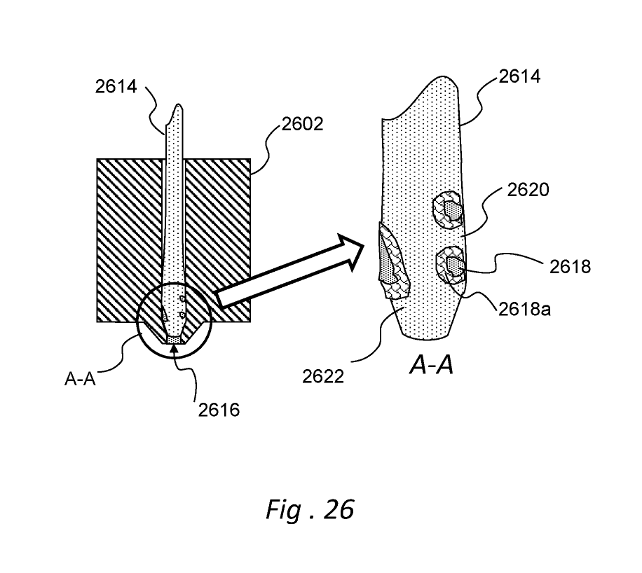

An enlarged view of a representative plunger 2614 is shown schematically in FIG. 26. The plunger 2614 is shown pressed against the outlet 2616 of the nozzle 2602, in the manner described above with respect to FIG. 25, with a particle 2618 and the particle plunger interaction region 2618a. As described above, it is beneficial for the plunger to be soft enough inside the nozzle to readily deform under compression and conform to the internal geometry of the nozzle bore. The ability of the plunger to deform readily under compression, allows it, for example, to penetrate into narrow gaps that may exist within or between deposits of solid material inside the nozzle 2620. Moreover, the plunger may be able to penetrate spaces below solid deposits that exhibit an overhang 2622. These spaces would not be accessible with a rigid plunger that is unable to conform to the internal geometry. This ability to adjust to the internal nozzle geometry allows the plunger to mechanically trap or enclose solid deposits 2618 inside the nozzle such that they can be extracted together with the plunger from the nozzle. Beyond this mechanical effect, the ability to conform to the nozzle geometry also increases the area of contact between the plunger and any debris that might have accumulated within the nozzle. This increase in contact area may enhance any physical and chemical interaction 2618a between the built-up debris and the plunger, which may result in an even stronger bond between the debris and the plunger and further aide extraction with the plunger.

Depending on the nature of the solid debris build up in the nozzle, a variety of physical and chemical processes may occur at the interaction region 2618a with the plunger. For instance, if the material of the plunger and the debris are miscible, interdiffusion of atomic species across the contact interface may result in formation of one cohesive solid. Moreover, if, for instance, the plunger material and the debris undergo a chemical reaction, electron exchange may result in covalent and ionic bonds between the debris and the plunger. Such strong chemical bonds between debris and plunger aide in extraction of the debris upon retracting the plunger from the nozzle. While it is beneficial for the plunger to easily conform to the nozzle geometry, the plunger also needs to be sufficiently strong not to break apart when it is retracted from the nozzle. These conditions can often be achieved by choosing a servicing temperature below, but close to the melting point of the plunger material, or choosing a plunger material with a melting point above but close to the servicing temperature, at which the plunger material would soften, and even in some circumstances become tacky. At the same time, as discussed above, in connection with the plunger DD04, shown in Fig. DD, used to eject readily extrudable liquid out of the nozzle outlet DD16, the plunger should not contaminate the material in the nozzle with undesirable species or mix or react with the material inside the nozzle to form mixtures or reaction products that could negatively impact the extrudability and properties of the build material. One approach to satisfying these requirements is to choose the plunger material from the same alloy family as the build material, or a closely related alloy composed of one or more of the alloy components present in the build material.

In one particularly desirable embodiment, the composition of the plunger material is chosen such that if intermixing between the plunger and built up solid occurs inside the nozzle, the resulting alloy has a lower melting point than the build material and thus does not impede future extrusion of the mixing product.

An example of this servicing procedure may include the following steps. For a zinc aluminum die-casting alloy, the nozzle is brought to a temperature of 415° C. and a plunger made up of a 99.5 wt. % zinc is used to expel all readily extrudable material from the nozzle. A second plunger, made from the same material is then used to remove any remaining built up solid from nozzle. This is achieved by pressing the second plunger into the nozzle, and to spin the plunger around or otherwise move the plunger inside the nozzle to maximize the contact between the plunger surface and any built up solid inside the nozzle. After removing the plunger, any remaining material in the nozzle is then purged by feeding new build material into the nozzle.

In multi-phase metal alloys, flow obstructions often originate from the build up of solid-phase particles inside the nozzle. As more and more material is extruded, built up solid particles can occupy a significant fraction of the overall nozzle bore volume.

Since the composition of the solid and liquid phases of a multi-phase metal alloy can be very different, a local build up of solid phase material may significantly shift the overall composition of the material contained within the finite volume of the extrusion nozzle away from the composition of the build material as supplied in the feedstock. Assuming the system is diffusion limited and the solid build up has reached a certain size, it may even be appropriate to treat the build up solid material as separate from the remainder of the multi-phase metal alloy (which is typically characterized by small solid particles suspended in a liquid matrix) and recognize that it has a different liquidus temperature consistent with its composition. Higher temperatures than would be expected from the original build material composition may thus be required to fully melt the material inside the extrusion nozzle. Heating the nozzle to a sufficiently high temperature to melt all the multi-phase metal inside the nozzle would homogenize the composition of the multi-phase material. Due to the overall shift in composition away from the original build material composition (because of a preferential expulsion from the nozzle of liquid of a composition that differs from that of the original build material), a subsequent reduction in temperature back to the operating temperature might still result in an elevated solid fraction that may not be suitable for extrusion.

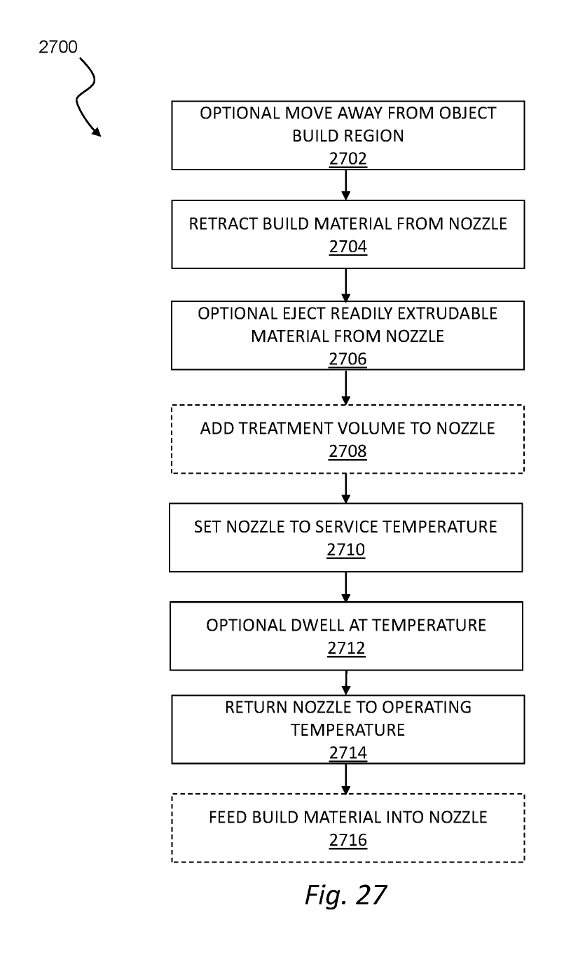

To successfully service the nozzle and achieve the desired liquid fraction at the operating temperature, it is beneficial to return the composition of the multi-phase material inside the nozzle close to the original build material composition (essentially replacing at least what has been preferentially removed as liquid, and, in some cases, even more of what has been depleted than the depletion amount, as explained below).—This can be achieved by using two related but distinct servicing techniques, which are describe schematically in flow chart form in FIG. 18 and FIG. 27. In one nozzle servicing technique 1800 (FIG. 18), described briefly above, the nozzle may be moved away from the object build area 1802, to the service area 818, so that the printed object is not fouled or damaged by the servicing routine The technique then continues by 1804 heating the nozzle to a temperature above the operating temperature. This may be followed by a dwell step 1806, at which the nozzle is kept at elevated temperature for a time to make sure that the material in the nozzle is in a readily extrudable or fully molten state. At elevated temperatures the nozzle may then be repeatedly purged 1808 by feeding build material into the nozzle inlet, melting that build material to become readily extrudable and then purging out the nozzle with the at least partially liquified build material. Purging helps to replace the material inside the nozzle with fresh build material, such that the overall composition of the material inside the nozzle returns to close to the original build material composition and thus exhibits a liquid fraction suitable for extrusion once the nozzle has been returned 1810 to the operating temperature.

The second technique 2700 to achieve a liquid fraction sufficiently high for extrusion at the operating temperature is describe schematically in flow chart form in FIG. 27. This technique deliberately shifts the material composition in the nozzle by adding a treatment of material with a composition that is different from the build material composition and that is chosen such that it increases the liquid fraction at the operating temperature to a level close to or above the one expected for the build material composition. Such treatment material may beneficially be added in solid form, such as pellet, shot or relatively short length of wire. At the operating temperature, the material inside the nozzle may then be purged by feeding new build material of the normal build material composition into the nozzle. It may be useful to think of this method as one in which a pill type treatment or therapy is applied to the material inside the nozzle to change its composition. The material added to the nozzle is thus referred to as treatment material in the following.

Another advantage of this servicing technique is that it can address the spatial buildups of phase-segregated material that may be physically disconnected from one another. For example, there could be material in the reducing section of a nozzle and some material that is stuck to the side walls of the nozzle, but not in physical contact with the aforementioned material in the reducing section. By introducing treatment material to the nozzle, preferably in a solid form that becomes liquid at the nozzle temperature, the effective fill height within the nozzle may increase and connect previously non-contiguous volumes through a liquid or liquid-rich phase. Neglecting foreign species, it would then be possible for all of the material within the nozzle to reach the same (thermodynamic equilibrium) composition, whereas previously it may not have been possible.

This servicing technique is described schematically in flow chart form in FIG. 27. As an optional first step, the nozzle may be moved away from the object build area 2702, to the service area 818, so that the printed object is not fouled or damaged by the servicing routine. Then the build material filament may be retracted from the nozzle 2704 to make room and provide better access to apply the treatment material. Before the treatment material is added, it may be beneficial to first 2706 expel any remaining easily extrudable material from the nozzle. In this way, small quantities of treatment material will have an outsized effect on the overall composition of the material in the nozzle. The readily extrudable material may be expelled by any of the techniques described herein, such as a plunger, a pressure differential and a gas flow. In order to facilitate expelling the readily extrudable material, the nozzle may be temporarily heated above the operating temperature and then returned back to the operating temperature. The treatment material, typically in a solid form, may then be added to the nozzle 2708. Typically, the treatment material is added at the operating temperature, but it may also be added while the nozzle is brought to 2710 a service temperature or after the nozzle has reached the service temperature. Depending on the treatment material, the service temperature may be higher or lower than the operating temperature. The existence of the multiple options of when to add the treatment material to the nozzle is indicated in FIG. 27 by the dashed circumference of step 2708. The treatment material is introduced into the nozzle, preferably, via the nozzle inlet. The treatment material may also be introduced from the nozzle outlet or any other pathway providing access to the nozzle bore. The treatment material may be in wire, filament, rod, pellet or powder form or any other suitable form to deliver the material into the extrusion nozzle. After the treatment material has been added and the nozzle has reached the desired service temperature, the nozzle may dwell at a temperature 2712 for a duration of time, to assure that the material inside the nozzle has sufficient time to alloy. As a next step, the nozzle temperature is set back to the operating temperature 2714 and fresh build material is fed into and extruded from the nozzle 2716 to purge out and replace the material contained in the nozzle with fresh build material. Instead of occurring after the nozzle has reached the operating temperature, this last extrusion step may also occur while the nozzle dwells at a temperature or while the nozzle temperature returns to the operating temperature. This plurality of options is indicated by the dashed circumference of step 2716.

The composition of the treatment material may be chosen based on the equilibrium phase diagram of the multi-phase metal build material. FIG. 19 shows such a phase diagram for a zinc and aluminum alloy, which is referred to in the following discussion. The treatment material may beneficially have a composition such that the liquidus temperature of the combined material (i.e. homogeneous mixture of material already in the nozzle plus the treatment material) is reduced. It may be particularly desirable to choose the composition of the treatment material such that the combined material exhibits the lowest melting temperature for a given build material alloy system. For multi-phase metal alloys from a eutectic alloy system this may be the eutectic temperature. FIG. 19 demonstrates the selection of a suitable composition for the added material for the eutectic alloy system of zinc and aluminum. For instance, for a build material with a composition 1902 of 80 at. % zinc and 20 at. % Aluminum at an extrusion temperature 1904 of 400 C, the solid 1906 has a composition of 65 at. % zinc and the liquid 1908 has a composition of 83% zinc. Following a build up of a significant amount of solid particles inside the nozzle, the overall composition in the nozzle 1910 may be shifted towards the composition of the solid, for instance to 70 at. % zinc. A zinc aluminum alloy with a zinc content higher than the 70 at. % zinc may then be added to the nozzle (as a wire, filament, rod, pellet or powder or any other suitable form to deliver the material into the extrusion nozzle) to counteract that shift, as indicated by the arrow pointing from the overall composition in the nozzle 1910 to the composition of the build material 1902. In a particularly beneficial implementation, zinc may be used as the added material, which maximizes the shift in composition on a per volume of treatment material basis.

While it is desirable for the treatment material to be a component of the build material alloy system, the treatment material may also be made of one or more components that are not part of the build material alloy system, as long as the melting temperature of the combined material decreases.

An example of the general servicing technique by which a treatment material is added may include the following steps. For a zinc aluminum die casting alloy, the build material filament is retracted from the nozzle and the nozzle is brought to a temperature of 415° C. A plunger made up of zinc is used to expel all readily extrudable material from the nozzle. A piece of zinc wire is then introduced into the nozzle and the nozzle is heated to 490° C. After a two minute dwell time, the nozzle temperature is then reduced back to 415° C. and the material in the nozzle is then purged by feeding new build material into the nozzle.

While the nozzle service techniques described above mainly apply to multi-phase metal alloys, flow obstructions due to build up of solid-phase particles inside the nozzle may also occur for other types of MCMP materials such as materials using a combination of a metallic base and a high temperature inert second phase. While many of the above described concept may still apply, the service techniques may require modifications to account for the differences in material properties. For instance, for materials using a combination of a metallic base and a high temperature inert second phase, the melting temperature of the inert second phase may be much higher than the melting temperature of the metallic base. In this case, increasing the temperature above the operating temperature with the aim of increasing the liquid fraction in the nozzle and getting the material into a fully liquid state may not be practical nor desirable. Instead, an alternative service technique, similar to the one described in FIG. 27, may be used. A treatment material may be introduced into the nozzle to increase the liquid fraction of the material inside the nozzle. In a particularly desirable embodiment, the treatment material may be the metallic base itself (without the inert second phase). However, any metallic material that is compatible with the metallic base and the inert second phase and whose addition significantly increases the amount of liquid present inside the nozzle may be a suitable choice for the treatment material.

Another method pertaining to nozzle service 900, shown schematically in flow chart form in FIG. 9, may be applied at any time. It would typically be performed after a nozzle service, to determine whether the service was successful in an automated fashion, regardless of the reasoning for the nozzle service (be it scheduled, reactive, or other). The technique described below can assist in the qualification of the effectiveness of a nozzle service and determination that the nozzle is in a state suitable for deposition before returning to fabrication of the object. It could also be conducted at any time that the operator, manually, or the controller, under some routine, determines that it would be beneficial to confirm that the nozzle is in good working order.

After a nozzle service is triggered 902 by the nozzle service scheduler, the controller moves the nozzle to the nozzle service location 904. The nozzle is serviced 906 via one of the aforementioned nozzle service techniques, and then a predetermined test extrusion is performed 908 at settings and parameters not dissimilar to those encountered during the deposition of the object. This involves the feeding of build material into the nozzle. The controller queries 910 whether the test extrusion is within specification based upon process feedback. For example, this may be being below some predetermined extrusion force. If the extrusion is within specification, then the controller may reset or restart any nozzle service criterion 912 and returns 914 to building the object. If the test extrusion is not within specification an unsuccessful service counter is incremented 916. A query is conducted 918 whether the unsuccessful service counter exceeds a threshold. If the answer is Yes, this means that the service routines are not working satisfactorily, and the operator is alerted 920. If the answer is No, then the nozzle is again serviced 906 and a test extrusion is performed 908, after which the test extrusion is evaluated as discussed above, the controller queries 910 whether it is within specification, and continues, as described above. In another embodiment, the difference in the extrusion force required before commencing a nozzle service and after completing a nozzle service may contain information as to the efficacy of the nozzle service and may be used as in the acceptance specification 910. In this way the specification may be determined relatively, rather than from predefined quantities. For example, if under the same processing condition, the extrusion force required prior to service was 20N and upon completion of service the force was 3N, the nozzle service may be deemed acceptable 910 and then proceeds to step 912. Whereas if the extrusion force upon completion of service was 25N, then the nozzle service may be deemed to have failed, and then proceeds to step 916. Furthermore, performing the test extrusion 908 before commencing nozzle service or before moving to the nozzle servicing station may serve as a check to see if the nozzle is in an error condition. If the nozzle passes this check, then the nozzle service may be aborted, and the fabrication of the object may subsequently resume.

Multiple successive failures may indicate a failure that cannot be resolved by the nozzle service methods described herein and may trigger manual intervention. Furthermore, frequent nozzle error conditions immediately following service may indicate an inability to properly service the nozzle and may trigger manual intervention. Additionally, more longer-term degradation, which may be captured by the nozzle health metric, may trigger manual intervention such as nozzle replacement.

Furthermore, process quantities may be used to adapt or vary the nozzle service procedure used. For example, a downwards trend in the amount of build material extruded between nozzle error conditions may prompt a more rigorous nozzle service routine, such as a service routine with a higher nozzle service temperature. Alternatively, a relatively more or relatively less rigorous nozzle service routine may be selected, based upon the performance of the nozzle. By way of non-limiting example, a more rigorous nozzle service routine may involve increasing the service temperature and/or the duration, acceleration and feed rate of the varying build material feed during a nozzle purging step. Conversely, a less rigorous nozzle service routine may involve a reduction of the aforementioned quantities.

In general, a nozzle service schedule may vary the method, duration, or rigor of the nozzle service. This may be predetermined based upon a recipe, or adapted based upon process conditions. By way of non-limiting example, repeating a pattern of ABAB may be used, where A denotes a nozzle service comprising increasing the nozzle temperature and pulsed purging extrusion and B denotes a nozzle service comprising an increase in temperature combined with the gas jet material purge.

A particularly desirable embodiment of a nozzle service routine for a zinc die casting alloy is as follows. It is assumed the nozzle has active heating and active cooling, for instance as described in detail in U.S. patent application Ser. No. 15/059,256, mentioned and incorporated by reference above, and that the nominal printing setpoint is 415° C. at the outlet and 365° C. at the inlet. After having moved the nozzle to the servicing location:

1. Retracting the build material feedstock material from the nozzle;

2. Turning off the nozzle cooling and heat the nozzle outlet region to 450° C.;

3. Extruding material with a time-varying feed rate (forwards at 70 mm/s for 8 mm, backwards at 70 mm/s for 6 mm) while simultaneously returning the nozzle to its nominal printing setpoint (415° C./365° C.) by reducing the heating input and resuming nozzle cooling;

4. Once the axial temperature profile within the nozzle returns to within a predefined, small error from the set-point, the same forwards and backwards extrusion continues for 5 seconds;

5. A test extrusion of 10 mm of feedstock at 15 mm/s where a successful clean is defined as an extrusion force below 10 N; and

6. A wipe across the nozzle outlet with a wire brush once from each direction to clean the exterior surfaces near the nozzle outlet.

All documents mentioned herein are incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term or should generally be understood to mean and/or and so forth.

Recitation of ranges of values herein are not intended to be limiting, referring instead individually to any and all values falling within the range, unless otherwise indicated herein, and each separate value within such a range is incorporated into the specification as if it were individually recited herein. The words about, approximately, substantially, or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (e.g., such as, or the like) provided herein, is intended merely to better illuminate the embodiments and does not pose a limitation on the scope of the embodiments or the claims. No language in the specification should be construed as indicating any unclaimed element as essential to the practice of the claimed embodiments.

In the foregoing description, it is understood that terms such as first, second, top, bottom, up, down, and the like, are words of convenience and are not to be construed as limiting terms unless specifically stated to the contrary.

Regarding metal build materials more specifically, this description emphasizes three-dimensional printers that deposit metal, metal alloys, or other metallic compositions for forming a three-dimensional object using fused filament fabrication or similar techniques. In these techniques, a segment of material is extruded in a layered series of two-dimensional patterns to form a three-dimensional object from a digital model. The segments may also be referred to as roads, beads or paths or lines. However, it will be understood that other additive manufacturing techniques and other build materials may also or instead be used with many of the techniques contemplated herein. Such techniques may benefit from the systems and methods described below, and all such printing technologies are intended to fall within the scope of this disclosure, and within the scope of terms such as printer, three-dimensional printer, fabrication system, additive manufacturing system, and so forth, unless a more specific meaning is explicitly provided or otherwise clear from the context. Further, if no type of printer is stated in a particular context, then it should be understood that any and all such printers are intended to be included, such as where a particular material, support structure, article of manufacture, or method is described without reference to a particular type of three-dimensional printing process.

The term extrudate refers to the build material that is exiting a nozzle, e.g., in a three-dimensional printing process. The verb to condition is used to mean the act of bringing a build material up to a temperature within its working range, where it has rheological behavior suitable for the printing process.

It will be appreciated that the foregoing techniques may be employed alone or in any suitable combination, and may be combined with other time varying extrusion feed rate regimes such as sinusoidal regimes, ramps, and so forth, provided that the aggregate rate profile supports extended clog-free extrusion as contemplated herein.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the present teachings as defined by the following claims, which are to be interpreted in the broadest sense allowable by law.

Aspects of the Present Teachings

The following aspects of present teachings hereof are intended to be described herein, and this section is to ensure that they are mentioned. They are named aspects, and although they appear similar to claims, they are not claims. However, at some point in the future, the applicants reserve the right to claim any and all of these aspects in this and any related applications.
A1. A method for servicing a nozzle of a three-dimensional printer, used for fabricating an object based on a computerized model of the object, by extruding metal containing multi-phase (MCMP) build material from the nozzle, the printer also comprising a build region, the nozzle having an inlet and an outlet, the steps of fabrication including feeding the MCMP build material into the nozzle inlet, and extruding MCMP build material from the nozzle outlet while establishing relative motion of the nozzle outlet relative to the build region along a build path to fabricate the object within the build region, the method for servicing comprising:
a. establishing at least one operating window size, at the conclusion of which nozzle service is scheduled;
b. establishing at least one process condition:
c. during the operating window, simultaneously with the steps of feeding, extruding and establishing relative motion of the nozzle outlet, monitoring at least one process condition;
   i. if the at least one processing condition has not arisen, continuing with the steps c. of feeding, extruding and establishing relative motion of the nozzle outlet and simultaneously monitoring whether the at least one processing condition has arisen; and
   ii. if the at least one processing condition has arisen:
      A. changing the size of the operating window;
      B. continuing the steps of feeding, extruding and establishing relative motion of the nozzle outlet until conclusion of the operating window with changed size, and then conducting nozzle service; and
      C. conducting the step c. above, during the operating window with changed size, the steps of feeding, extruding and establishing relative motion of the nozzle and simultaneously monitoring whether the at least one processing condition has arisen.
A2. The method of aspect 1, the step of changing the size of the operating window comprising reducing the size of the operating window.
A3. The method of aspect 1, the step of changing the size of the operating window comprising enlarging the size of the operating window.
A4. The method of aspect 1, the step c. ii. B further comprising monitoring whether the at least one processing condition has arisen, and if it has, again changing the size of the operating window
A5. The method of aspect 4, the steps of continuing the steps of feeding, extruding and establishing relative motion of the nozzle outlet until conclusion of the operating window with changed size comprising continuing the steps of feeding, extruding and establishing relative motion of the nozzle outlet until conclusion of the operating window with again changed size.
A6. The method of aspect 1, the size of the operating window being measured by at least one of the group consisting of: elapsed extruding time; elapsed absolute time, extruded distance, extruded mass, extruded volume, number of extruded segments, number of extruded layers; and amount of extruding, as measured by any one of the foregoing, before next critical geometry.
A7. The method of aspect 1, the printer further comprising a build material feeder system, the at least one process condition being selected from the group consisting of: extrusion force, optically observed condition of build material as extruded, elapsed extrusion time, distance of material deposited, mass of material deposited, volume of material deposited, number of segments deposited, number of layers deposited, average of any of the foregoing, moving average of any of the foregoing, and exponentially weighted moving average of any of the foregoing.
A8. The method of aspect A1, the printer further comprising a build material feeder system that comprises an electric motor, the at least one process condition comprising current drawn by the motor.
A9. The method of aspect A1, the steps of feeding the build material into the nozzle inlet and extruding build material from the nozzle outlet to fabricate the object on the build region comprising extruding build material in a set of individual segments, the step of changing the size of the operating window comprising changing it to a size so that it terminates after completion of an individual segment and before beginning an individual segment.
A10. The method of aspect 9, the step of extruding build material in a set of individual path segments further comprising extruding a set of individual path segments in a layer of path segments, the step of changing the size of the operating window comprising changing it to a size so that it terminates after completion of an individual layer of segments and before beginning an individual layer of segments.
A11. The method of aspect 1, the at least one processing condition comprising a preset value.
A12. The method of aspect 1, the at least one processing condition comprising a dynamic value.
A13. A method for servicing a nozzle of a three-dimensional printer, used for fabricating an object based on a computerized model of the object, by extruding metal containing multi-phase (MCMP) build material from the nozzle, the printer also comprising a build region, the nozzle having an inlet and an outlet, the steps of fabrication including feeding the MCMP build material into the nozzle inlet, and extruding MCMP build material from the nozzle outlet while establishing relative motion of the nozzle outlet in a set of individual segments relative to the build region along a build path to fabricate the object within the build region, the method for servicing comprising:
a. establishing at least one operating window size, at the conclusion of which nozzle service is scheduled;
b. establishing at least one process condition; and
c. during the operating window, simultaneously with the steps of feeding, extruding and establishing relative motion of the nozzle outlet, monitoring at least one process condition:
   i. if the at least one processing condition has not arisen, continuing with the steps c. of feeding, extruding and establishing relative motion of the nozzle outlet and simultaneously monitoring whether the at least one processing condition has arisen until conclusion of the operating window; and
   ii. if the at least one processing condition has arisen, continuing the steps of feeding, extruding and establishing relative motion of the nozzle outlet until after a segment has been extruded, and then, before extruding an additional segment, conducting nozzle service.
A14. The method of aspect 13, the processing condition having arisen when a specific segment was being extruded, the step of continuing the steps of feeding, extruding and establishing relative motion of the nozzle outlet until after a segment has been extruded comprising continuing the steps of feeding, extruding and establishing relative motion of the nozzle outlet until after the segment that was being extruded when the processing condition arose, has been extruded.
A15. The method of aspect 13, the processing condition having arisen when a specific segment was being extruded, the step of continuing the steps of feeding, extruding and establishing relative motion of the nozzle outlet until after a segment has been extruded comprising continuing the steps of feeding, extruding and establishing relative motion of the nozzle outlet until after a plurality of segments have been extruded after the segment that was being extruded when the processing condition arose, has been extruded.
A16. The method of aspect 13, the printer further comprising a build material feeder system, the at least one process condition being selected from the group consisting of: extrusion force, optically observed condition of build material as extruded, elapsed extrusion time, distance of material deposited, mass of material deposited, volume of material deposited, number of segments deposited, number of layers deposited, average of any of the foregoing, moving average of any of the foregoing, and exponentially weighted moving average of any of the foregoing.
A17. The method of aspect 13, the build material feeder system comprising an electric motor, the at least one service criterion comprising current drawn by the motor.
A18. The method of aspect 13, the at least one process condition comprising an extrapolation function of a measured parameter over time.
A19. The method of aspect 18, the extrapolation function of a measured parameter over time comprising an extrapolation function of a plurality of measured parameters over time.
A20. A method for servicing a nozzle of a three-dimensional printer, used for fabricating an object based on a computerized model of the object, by extruding metal containing multi-phase (MCMP) build material from the nozzle, the printer also comprising a build region, the nozzle having an inlet and an outlet, the steps of fabrication including feeding the MCMP build material into the nozzle inlet, and extruding MCMP build material from the nozzle outlet in a set of individual segments, each segment having a size, while establishing relative motion of the nozzle outlet relative to the build region along a build path to fabricate the object within the build region, the method for servicing comprising:
a. establishing at least one operating window size at the conclusion of which a nozzle service is scheduled;
b. establishing at least process condition; and
c. during the operating window, simultaneously with the steps of feeding, extruding and moving the nozzle, monitoring at least one process condition, and determining whether the at least one process condition will arise before completion of an upcoming segment:
   i. if the at least one processing condition will not arise before completion of an upcoming segment, continuing with the steps c. of feeding, extruding and establishing relative motion of the nozzle outlet and determining whether the at least one process condition will arise before completion of an upcoming segment; and
   ii. if the at least one processing condition will arise before completion of an upcoming segment: taking a step chosen from the three options consisting of:
      A. continuing feeding the MCMP build material into the nozzle inlet and extruding MCMP build material from the nozzle outlet while establishing relative motion of the nozzle outlet along a build path to fabricate the object, until the end of the upcoming segment has been extruded, and then conducting nozzle service;
      B. ceasing feeding the MCMP build material into the nozzle inlet and ceasing extruding MCMP build material from the nozzle outlet and conducting nozzle service before fabricating the upcoming segment; and
      C. splitting the upcoming segment into a plurality of shorter segments, and continuing feeding the MCMP build material into the nozzle inlet and extruding MCMP build material from the nozzle outlet while establishing relative motion of the nozzle outlet along a build path to fabricate the object, until the end of the at least one of the plurality of shorter segments has been extruded, and then conducting nozzle service.
A21. The method of aspect 20, the step of determining whether the at least one process condition will arise before completion of an upcoming segment being conducted before extrusion of a next upcoming segment and the result of the step of determining whether the at least one process condition will arise before completion of an upcoming segment comprising that the processing condition will arise before completion of the next upcoming segment, the step comprising taking a step chosen from the three options comprising taking a step chosen from the three options consisting of:
   A. continuing feeding the MCMP build material into the nozzle inlet and extruding MCMP build material from the nozzle outlet while establishing relative motion of the nozzle outlet along a build path to fabricate the object, until the end of the next upcoming segment has been extruded, and then conducting nozzle service;
   B. ceasing feeding the MCMP build material into the nozzle inlet and ceasing extruding MCMP build material from the nozzle outlet and conducting nozzle service before fabricating the next upcoming segment; and
   C. splitting the next upcoming segment into a plurality of shorter segments, and continuing feeding the MCMP build material into the nozzle inlet and extruding MCMP build material from the nozzle outlet while establishing relative motion of the nozzle outlet along a build path to fabricate the object, until the end of the at least one of the plurality of shorter segments has been extruded, and then conducting nozzle service.
A22. A method for servicing a nozzle of a three-dimensional printer, used for fabricating an object based on a computerized model of the object, by extruding metal containing multi-phase (MCMP) build material from the nozzle, the printer also comprising a build region, the nozzle having an inlet and an outlet, the steps of fabrication including feeding the MCMP build material into the nozzle inlet, establishing the nozzle at an operating temperature, and extruding MCMP build material from the nozzle outlet while establishing relative motion of the nozzle outlet relative to the build region along a build path to fabricate the object within the build region, the method for servicing comprising:
a. ceasing feeding the MCMP build material into the nozzle and ceasing extruding MCMP build material from the nozzle;
b. moving the nozzle away from the build path to a service area;
c. conducting nozzle service by ejecting a quantity of build material from the nozzle;
d. returning the nozzle to the build path; and
e. restarting and continuing with the steps of feeding, extruding and establishing relative motion of the nozzle outlet.
A23. The method of aspect 22, the step of conducting nozzle service further comprising, before the step of ejecting a quantity of build material, the step of increasing the temperature of the nozzle to greater than the operating temperature.
A24. The method of aspect 22, the step of ejecting a quantity of build material from the nozzle outlet comprising driving build material into the nozzle inlet.
A25. The method of aspect 22, further comprising the step of providing at the nozzle service area a receptacle for build material that is ejected during the nozzle service.
A26. The method of aspect 22, the nozzle service area being vertically spaced away from the build plate and also vertically above and within an upward projection of the object build region.
A27. The method of aspect 22, further the step of ejecting a quantity of build material from the nozzle comprising the step of varying the rate at which build material is fed into the nozzle inlet.
A28. The method of aspect 27, the step of varying the rate at which build material is fed into the nozzle inlet comprising reversing the direction of feed of the build material out of and then again into the nozzle inlet.
A29. The method of aspect 22, the step of ejecting a quantity of build material from the nozzle comprising inserting a plunger into the nozzle and ejecting build material from within the nozzle.
A30. The method of aspect 29, the step of inserting a plunger into the nozzle comprising inserting a plunger into the nozzle inlet, and the step of ejecting build material comprises forcing build material through the nozzle and out of the nozzle outlet.
A31. The method of aspect 30, the plunger having a diameter that is sized to pass entirely through the nozzle from inlet to outlet.
A32. The method of aspect 29, the step of inserting a plunger into the nozzle comprising inserting a plunger into the nozzle inlet, which plunger comprises a build material capture feature, the step of ejecting build material comprising capturing build material with the plunger and then retracting the plunger back out of the nozzle inlet, thereby ejecting captured build material from the nozzle out of the nozzle inlet.
A33. The method of aspect 29 further comprising the step of inserting a second plunger into the nozzle inlet, which second plunger comprises a build material capture feature, further comprising the step of capturing build material with the second plunger and then retracting the second plunger back out of the nozzle inlet, thereby removing any captured build material from the nozzle out of the nozzle inlet.
A34. The method of aspect 29, the plunger having an extension along an axis, further comprising the step of rotating the plunger around the axis of extension.
A35. The method of aspect 32, the build material capture feature being selected from the group consisting of: chemically bonding with build material; interdiffusion of atomic species between the particles and the plunger, forming a cohesive solid; mechanically trapping build material within space between components of the plunger; softening the plunger so that the plunger deforms around particles pressed against plunger and retains particles to the plunger.
A36. The method of aspect 29, the step of inserting a plunger into the nozzle comprising inserting a plunger into the nozzle inlet, which plunger has a diameter that is larger than the diameter of the nozzle outlet, further comprising the step of providing a servicing temperature and pressing the plunger with sufficient force against the nozzle outlet such that the plunger deforms around particles against which the plunger presses, so that the particles are captured by the plunger.
A37. The method of aspect 32 further comprising the step of, before for a second time, inserting a plunger, conducting the step of raising the temperature to approximately the softening temperature of the nozzle used for the second insertion.
A38. The method of aspect 22, further comprising the step of applying a pressure differential between the nozzle inlet and the nozzle outlet.
A39. The method of aspect 38, the step of applying a pressure differential between the nozzle inlet and the nozzle outlet comprising applying a larger pressure at the nozzle inlet than pressure at the nozzle outlet.
A40. The method of aspect 38, the step of applying a pressure differential between the nozzle inlet and the nozzle outlet comprising applying a larger pressure at the nozzle outlet than pressure at the nozzle inlet.
A41. The method of aspect 38, the step of applying a pressure differential comprising applying a fluid jet at one of the nozzle inlet and the nozzle outlet.
A42. The method of aspect 38, the step of applying a pressure differential comprising applying a vacuum at one of the nozzle inlet and the nozzle outlet.
A43. The method of aspect 41, the fluid comprising a gas.
A44. The method of aspect 41, the fluid comprising a liquid.
A45. The method of aspect 34, the step of heating the nozzle further comprising heating the nozzle so the build material liquid content increases.
A46. The method of aspect 45, the step of heating the nozzle comprising heating the nozzle so that the build material liquid content increases, and then maintaining the nozzle at the elevated temperature for a dwell duration.
A47. The method of aspect 45, the MCMP build material having a working temperature range between a solidus and a liquidus, the step of heating the nozzle comprising heating the nozzle so that the temperature of the build material exceeds the liquidus temperature of the MCMP build material.
A48. A method for servicing a nozzle of a three-dimensional printer, used for fabricating an object based on a computerized model of the object, by extruding metal containing multi-phase (MCMP) build material from the nozzle, the printer also comprising a build region, the nozzle having an inlet and an outlet, the steps of fabrication including feeding the MCMP build material into the nozzle inlet, establishing the nozzle at an operating temperature, and extruding MCMP build material from the nozzle outlet while establishing relative motion of the nozzle outlet relative to the build region along a build path to fabricate the object within the build region, the method for servicing comprising:
a. ceasing feeding the MCMP build material into the nozzle and ceasing extruding MCMP build material from the nozzle; and
b. maintaining the nozzle at a temperature for a dwell time.
A49. The method of aspect 48, further comprising the step of restarting and continuing with the steps of feeding, extruding and establishing relative motion of the nozzle outlet.
A50. The method of aspect 48, the step maintaining the nozzle at a temperature for a dwell time comprising maintaining the nozzle at the operating temperature.
A51. The method of aspect 48, the step maintaining the nozzle at a temperature for a dwell time comprising raising the temperature to an elevated temperature above the operating temperature and maintaining the nozzle at the elevated temperature.
A52. The method of aspect 51, the (MCMP) build material having a liquidus temperature, the elevated temperature comprising a temperature at least as high as the liquidus temperature.
A53. The method of aspect 48, the step maintaining the nozzle at a temperature for a dwell time comprising lowering the temperature to a reduced temperature lower than the operating temperature and maintaining the nozzle at the reduced temperature.
A54. The method of aspect 53, the (MCMP) build material having a solidus temperature, the reduced temperature comprising a temperature at least as low as the solidus temperature.
A55. The method of aspect 48, further comprising the step of providing a treatment material into the nozzle.
A56. The method of aspect 55, the build material having a composition, the treatment material having a composition that is different from the build material composition and that is chosen such that it increases the liquid fraction of the material in the nozzle at the operating temperature
A57. The method of aspect 55, the treatment material having a composition that is chosen such that it increases the liquid fraction of the material in the nozzle to a level close to or above the one expected for the build material composition.
A58. The method of aspect 55, the treatment material comprising a solid.
A59. The method of aspect 55, the step of providing a treatment material comprising providing a treatment material into the inlet of the nozzle.
A60. The method of aspect 55, further comprising, after the step of providing treatment material into the nozzle, the step of feeding build material into the nozzle.
A61. A method for servicing a nozzle of a three-dimensional printer, used for fabricating an object based on a computerized model of the object, by extruding metal containing multi-phase (MCMP) build material from the nozzle, the printer also comprising a build region, the nozzle having an inlet and an outlet, the steps of fabrication including feeding the MCMP build material into the nozzle inlet, and extruding MCMP build material from the nozzle outlet while establishing relative motion of the nozzle outlet relative to the build region along a build path to fabricate the object within the build region, the method for servicing comprising:
a. establishing at least one operating window size, at the conclusion of which nozzle service is scheduled;
b. establishing at least one nozzle health replacement condition; and
c. during the operating window, simultaneously with the steps of feeding, extruding and establishing relative motion of the nozzle outlet, monitoring at least one nozzle health replacement condition:
   i. if the at least one nozzle health replacement condition has not arisen, continuing with the steps c. of feeding, extruding and establishing relative motion of the nozzle outlet and simultaneously monitoring whether the at least one processing condition has arisen; and
   ii. if the at least one nozzle health replacement condition has arisen, replacing the nozzle.

What is claimed is:

1. A method for servicing a nozzle of a three-dimensional printer used for fabricating an object based on a computerized model of the object by extruding metal containing multi-phase (MCMP) build material from the nozzle, the printer also comprising a build region, the nozzle having an inlet and an outlet, the steps of fabrication including feeding the MCMP build material into the nozzle inlet, and extruding MCMP build material from the nozzle outlet while establishing relative motion of the nozzle outlet relative to the build region along a build path to fabricate the object within the build region, the method for servicing comprising:
a. establishing a size of at least one operating window, at the conclusion of which nozzle service is scheduled;
b. establishing at least one process condition;
c. during the operating window, simultaneously with the steps of feeding, extruding, and establishing relative motion of the nozzle outlet, monitoring at least one processing condition;
i. if the at least one processing condition has not arisen, continuing with the steps of feeding, extruding, and establishing relative motion of the nozzle outlet and simultaneously monitoring whether the at least one processing condition has arisen; and
ii. if the at least one processing condition has arisen:
A. changing the size of the operating window;
B. continuing the steps of feeding, extruding, and establishing relative motion of the nozzle outlet until conclusion of the operating window with a changed size, and then conducting nozzle service; and
C. conducting step c. above during the operating window with the changed size.

2. The method of claim 1, the step c. ii. B, further comprising monitoring whether the at least one processing condition has arisen, and if it has, again changing the size of the operating window

3. The method of claim 2, the steps of continuing the steps of feeding, extruding and establishing relative motion of the nozzle outlet until conclusion of the operating window with changed size comprising continuing the steps of feeding, extruding and establishing relative motion of the nozzle outlet until conclusion of the operating window with again changed size.

4. The method of claim 1, the printer further comprising a build material feeder system, the at least one process condition being selected from the group consisting of: extrusion force, optically observed condition of build material as extruded, elapsed extrusion time, distance of material deposited, mass of material deposited, volume of material deposited, number of segments deposited, number of layers deposited, average of any of the foregoing, moving average of any of the foregoing, and exponentially weighted moving average of any of the foregoing.

5. The method of claim 1, the steps of feeding the build material into the nozzle inlet and extruding build material from the nozzle outlet to fabricate the object on the build region comprising extruding build material in a set of individual segments, the step of changing the size of the operating window comprising changing it to a size so that it terminates after completion of an individual segment and before beginning an individual segment.

6. The method of claim 1, the at least one processing condition comprising a dynamic value.

7. A method for servicing a nozzle of a three-dimensional printer used for fabricating an object based on a computerized model of the object by extruding metal containing multi-phase (MCMP) build material from the nozzle, the printer also comprising a build region, the nozzle having an inlet and an outlet, the steps of fabrication including feeding the MCMP build material into the nozzle inlet, and extruding MCMP build material from the nozzle outlet while establishing relative motion of the nozzle outlet in a set of individual segments relative to the build region along a build path to fabricate the object within the build region, the method for servicing comprising:
a. establishing at least one operating window, at the conclusion of which nozzle service is scheduled;
b. establishing at least one process condition; and
c. during the operating window, simultaneously with feeding, extruding, and establishing relative motion of the nozzle outlet, monitoring at least one process condition:
i. if the at least one processing condition has not arisen, continuing with feeding, extruding, and establishing relative motion of the nozzle outlet and simultaneously monitoring whether the at least one processing condition has arisen until conclusion of the operating window; and
ii. if the at least one processing condition has arisen, continuing the steps of feeding, extruding and establishing relative motion of the nozzle outlet until after a segment has been extruded, and then, before extruding an additional segment, conducting nozzle service.

8. The method of claim 7, the processing condition having arisen when a specific segment was being extruded, the step of continuing the steps of feeding, extruding and establishing relative motion of the nozzle outlet until after a segment has been extruded comprising continuing the steps of feeding, extruding and establishing relative motion of the nozzle outlet until after the segment that was being extruded when the processing condition arose, has been extruded.

9. The method of claim 7, the processing condition having arisen when a specific segment was being extruded, the step of continuing the steps of feeding, extruding and establishing relative motion of the nozzle outlet until after a segment has been extruded comprising continuing the steps of feeding, extruding and establishing relative motion of the nozzle outlet until after a plurality of segments have been extruded after the segment that was being extruded when the processing condition arose, has been extruded.

10. The method of claim 7, the at least one process condition comprising an extrapolation function of a measured parameter over time.

11. The method of claim 10, the extrapolation function of a measured parameter over time comprising an extrapolation function of a plurality of measured parameters over time.

12. A method for servicing a nozzle of a three-dimensional printer used for fabricating an object based on a computerized model of the object by extruding metal containing multi-phase (MCMP) build material from the nozzle, the printer also comprising a build region, the nozzle having an inlet and an outlet, the steps of fabrication including feeding the MCMP build material into the nozzle inlet, and extruding MCMP build material from the nozzle outlet in a set of individual segments, each segment having a size, while establishing relative motion of the nozzle outlet relative to the build region along a build path to fabricate the object within the build region, the method for servicing comprising:
a. establishing at least one operating window, at the conclusion of which a nozzle service is scheduled;
b. establishing at least process condition; and
c. during the operating window, simultaneously with feeding, extruding, and moving the nozzle, monitoring at least one process condition, and determining whether the at least one process condition will arise before completion of an upcoming segment:
i. if the at least one processing condition will not arise before completion of an upcoming segment, continuing with feeding, extruding, and establishing relative motion of the nozzle outlet and determining whether the at least one process condition will arise before completion of an upcoming segment; and
ii. if the at least one processing condition will arise before completion of an upcoming segment, taking a step chosen from three options consisting of:
A. continuing feeding the MCMP build material into the nozzle inlet and extruding MCMP build material from the nozzle outlet while establishing relative motion of the nozzle outlet along a build path to fabricate the object, until the end of the upcoming segment has been extruded, and then conducting nozzle service;
B. ceasing feeding the MCMP build material into the nozzle inlet and ceasing extruding MCMP build material from the nozzle outlet and conducting nozzle service before fabricating the upcoming segment; and
C. splitting the upcoming segment into a plurality of shorter segments, and continuing feeding the MCMP build material into the nozzle inlet and extruding MCMP build material from the nozzle outlet while establishing relative motion of the nozzle outlet along a build path to fabricate the object, until the end of the at least one of the plurality of shorter segments has been extruded, and then conducting nozzle service.

13. A method for servicing a nozzle of a three-dimensional printer used for fabricating an object based on a computerized model of the object by extruding metal containing multi-phase (MCMP) build material from the nozzle, the printer also comprising a build region, the nozzle having an inlet and an outlet, the steps of fabrication including feeding the MCMP build material into the nozzle inlet, establishing the nozzle at an operating temperature, and extruding MCMP build material from the nozzle outlet while establishing relative motion of the nozzle outlet relative to the build region along a build path to fabricate the object within the build region, the method for servicing comprising:
a. ceasing feeding the MCMP build material into the nozzle and ceasing extruding the MCMP build material from the nozzle;
b. moving the nozzle away from the build path to a service area;
c. conducting nozzle service by ejecting a quantity of build material from the nozzle;
d. returning the nozzle to the build path; and
e. restarting and continuing with the steps of feeding, extruding, and establishing relative motion of the nozzle outlet.

14. The method of claim 13, further comprising the step of providing at the nozzle service area a receptacle for build material that is ejected during the nozzle service.

15. The method of claim 13, further the step of ejecting a quantity of build material from the nozzle comprising the step of varying the rate at which build material is fed into the nozzle inlet.

16. The method of claim 15, the step of varying the rate at which build material is fed into the nozzle inlet comprising reversing the direction of feed of the build material out of and then again into the nozzle inlet.

17. The method of claim 13, the step of ejecting a quantity of build material from the nozzle comprising inserting a plunger into the nozzle and ejecting build material from within the nozzle.

18. The method of claim 17, the step of inserting a plunger into the nozzle comprising inserting a plunger into the nozzle inlet, which plunger has a diameter that is larger than the diameter of the nozzle outlet, further comprising the step of providing a servicing temperature and pressing the plunger with sufficient force against the nozzle outlet such that the plunger deforms around particles against which the plunger presses, so that the particles are captured by the plunger.

19. The method of claim 13, further comprising the step of applying a pressure differential between the nozzle inlet and the nozzle outlet.

20. The method of claim 13, the step of applying a pressure differential comprising applying a gas jet at one of the nozzle inlet and the nozzle outlet.

21. A method for servicing a nozzle of a three-dimensional printer used for fabricating an object based on a computerized model of the object by extruding metal containing multi-phase (MCMP) build material from the nozzle, the printer also comprising a build region, the nozzle having an inlet and an outlet, the steps of fabrication including feeding the MCMP build material into the nozzle inlet, establishing the nozzle at an operating temperature, and extruding MCMP build material from the nozzle outlet while establishing relative motion of the nozzle outlet relative to the build region along a build path to fabricate the object within the build region, the method for servicing comprising:
a. ceasing feeding the MCMP build material into the nozzle and ceasing extruding the MCMP build material from the nozzle; and
b. maintaining the nozzle at a temperature for a dwell time.

22. The method of claim 22, the step maintaining the nozzle at a temperature for a dwell time comprising maintaining the nozzle at the operating temperature.

23. The method of claim 21, the step maintaining the nozzle at a temperature for a dwell time comprising lowering the temperature to a reduced temperature lower than the operating temperature and maintaining the nozzle at the reduced temperature.

24. The method of claim 23, the MCMP build material having a solidus temperature, the reduced temperature comprising a temperature at least as low as the solidus temperature.

25. The method of claim 21, further comprising the step of providing a treatment material into the nozzle.

26. The method of claim 25, the build material having a composition, the treatment material having a composition that is different from the build material composition and that is chosen such that it increases the liquid fraction of the material in the nozzle at the operating temperature

27. The method of claim 25, the treatment material comprising a solid.

28. The method of claim 25, further comprising, after the step of providing treatment material into the nozzle, the step of feeding build material into the nozzle.

29. A method for servicing a nozzle of a three-dimensional printer used for fabricating an object based on a computerized model of the object by extruding metal containing multi-phase (MCMP) build material from the nozzle, the printer also comprising a build region, the nozzle having an inlet and an outlet, the steps of fabrication including feeding the MCMP build material into the nozzle inlet, and extruding MCMP build material from the nozzle outlet while establishing relative motion of the nozzle outlet relative to the build region along a build path to fabricate the object within the build region, the method for servicing comprising:
a. establishing at least one operating window, at the conclusion of which nozzle service is scheduled;
b. establishing at least one nozzle health replacement condition; and
c. during the operating window, simultaneously with the steps of feeding, extruding, and establishing relative motion of the nozzle outlet, monitoring at least one nozzle health replacement condition:
i. if the at least one nozzle health replacement condition has not arisen, continuing with the steps c. of feeding, extruding and establishing relative motion of the nozzle outlet and simultaneously monitoring whether the at least one processing condition has arisen; and
ii. if the at least one nozzle health replacement condition has arisen, replacing the nozzle.
